(19) United States
(12) Patent Application Publication
(10) Pub. No.: US 2026/0095788 A1
(43) Pub. Date: Apr. 2, 2026

(54) FLEXIBLE CHANNEL STATE INFORMATION FRAMEWORK

(71) Applicant: InterDigital Patent Holdings, Inc., Wilmington, DE (US)

(72) Inventors: Mohammad Irfan, Chateauguay (CA); Loic Canonne-Velasquez, Dorval (CA); Jonghyun Park, Syosset, NY (US); Omid Saatlou, Montreal (CA); Afshin Haghighat, Ile-Bizard (CA); Moon IL Lee, Melville, NY (US); Virgil Comsa, Montreal (CA)

(73) Assignee: InterDigital Patent Holdings, Inc., Wilmington, DE (US)

(21) Appl. No.: 18/901,493

(22) Filed: Sep. 30, 2024

(51) Int. Cl. H04W 24/10; H04L 5/00

(52) U.S. Cl. CPC H04W 24/10; H04L 5/0087; H04L 5/0057

(57) ABSTRACT

A wireless transmit/receive unit may be configured to receive a channel state information (CSI) configuration. The CSI configuration may indicate a set of one or more CSI reference points. The WTRU may receive a trigger to perform a CSI report. The WTRU may determine that a CSI timing violation has occurred. The WTRU may generate a partial CSI based on the occurrence of the CSI timing violation. The partial CSI may be based on a subset of the quantities that the WTRU would normally use to generate a CSI report. The partial CSI may also be generated using a second time window, which may be shorter and/or have fewer sub-windows than the time window that the WTRU would normally use to generate a CSI report. The WTRU may send a report based on the partial CSI to the network.

### BACKGROUND

The 5G CSI framework supports periodic (P), semi-persistent (SP), and aperiodic (AP) channel state information (CSI) reference signals (RSs) (e.g., P CSI-RS, SP CSI-RS, and/or AP CSI-RS) and P, SP, and AP CSI reporting. The time-domain behavior of each of the P CSI-RS, SP CSI-RS, and AP CSI-RS and the P, SP, and AP CSI reporting is different. The existing framework uses four different types of references (e.g., time-domain symbol indices) for CSI-RS reception, CSI determination, and CSI reporting.

The existing CSI framework and the associated wireless transmit/receive unit (WTRU) behaviors are very rigid (e.g., not flexible enough or not adaptive) in terms of the CSI timeline. In terms of the CSI-RS reception and the follow-up WTRU behavior(s) or WTRU processing(s) of the reference signal (RS) (e.g., CSI-RS) for CSI determination and reporting. For example, the existing CSI framework is not flexible enough and restricts the WTRU in providing valuable CSI information to the gNB. For instance, when the WTRU receives a CSI-RS resource after the reference resource slot, the WTRU may drop the CSI report. However, a more capable WTRU (e.g., capable in terms of computational power) may be able to determine a valid full CSI or a valid partial CSI even when a CSI-RS resource is received after the reference resource and can prepare the UL transmission (e.g., PUCCH or PUSCH) for reporting of the CSI, but instead the WTRU drops the CSI report.

### SUMMARY

The solutions discussed herein relate to enhanced WTRU behaviors for channel state information (CSI) reference signal (RS) reception, CSI-RS processing for CSI determination, and/or CSI reporting.

A WTRU may determine if the CSI timeline is violated. For example, the CSI-RS is received after a reference point in time. The WTRU may determine a partial CSI when the CSI timeline is violated. In examples, instead of the full CSI report, the WTRU may determine a subset of the configured quantities to be reported in the CSI report. The WTRU may report a partial CSI report.

In examples, the WTRU may receive a CSI configuration. The CSI configuration may indicate a time instance associated with a trigger for the WTRU to perform CSI reporting and/or a time instance for an uplink transmission associated with CSI reporting. The CSI configuration may comprise a set of CSI reference instances and may indicate a set of quantities and/or a time window for CSI reporting.

The WTRU may determine that a CSI timing violation has occurred. The WTRU may determine to generate a partial CSI. In examples, the WTRU may make such a determination based on an association between a time instance associated with CSI reporting and one or more of the CSI reference instances. For example, the WTRU may determine to generate a partial CSI based on a time instance associated with CSI reporting (e.g., the time instance associated with a trigger for the WTRU to perform CSI reporting and/or the time instance for an uplink transmission associated with CSI reporting) is before or after one or more instances of the one or more CSI reference instances.

The WTRU may determine to use a second time window or a second set of quantities for CSI reporting. The second time window may comprise a different number of (e.g., fewer) windows than the first time window (e.g., the time window indicated in the CSI configuration). The sub-windows of the second time window may be of a different (e.g., shorter) duration than the sub-windows of the first time window. The second sub-window may start earlier, at the same time, or later than the first time window. The second set of quantities may comprise different quantities than the first (e.g., configured in the CSI configuration) set of quantities. For example, the second set of quantities may be a subset of the first set of quantities.

The WTRU may send a report (e.g., to the network), wherein the report indicates the CSI generated using the second time window and/or second set of quantities.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a timing diagram showing an example of channel state information (CSI) reference signal (RS) reception, CSI determination, and CSI reporting based on the CSI timeline.

FIG. 3 is a flow chart depicting an example of a process for a flexible CSI framework.

FIG. 4 is a timing diagram showing an example of an application involving a periodic CSI-RS and periodic CSI reporting.

FIG. 5 is a timing diagram showing an example of high Doppler CSI enhancements wherein aperiodic CSI-RS resources are used for determining a CSI.

FIG. 6 is a timing diagram showing an example timing diagram for high Doppler CSI enhancements.

### DETAILED DESCRIPTION

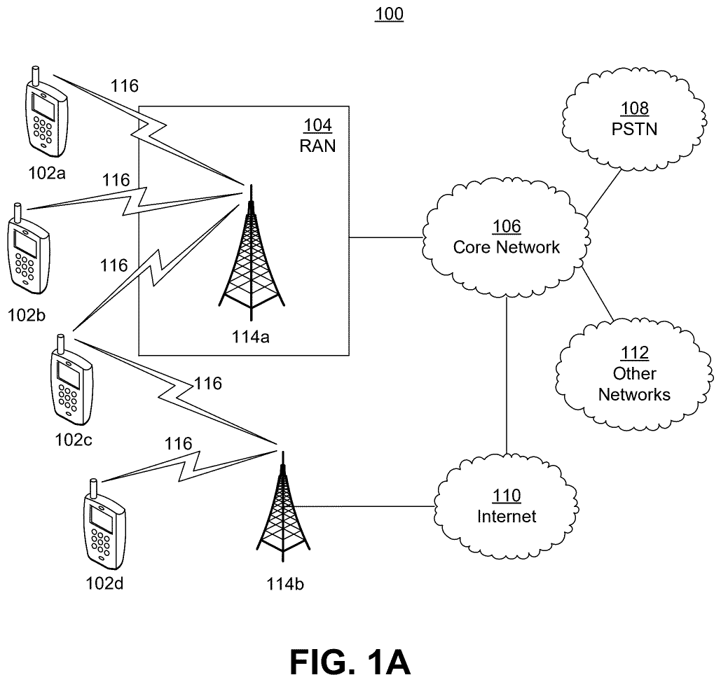

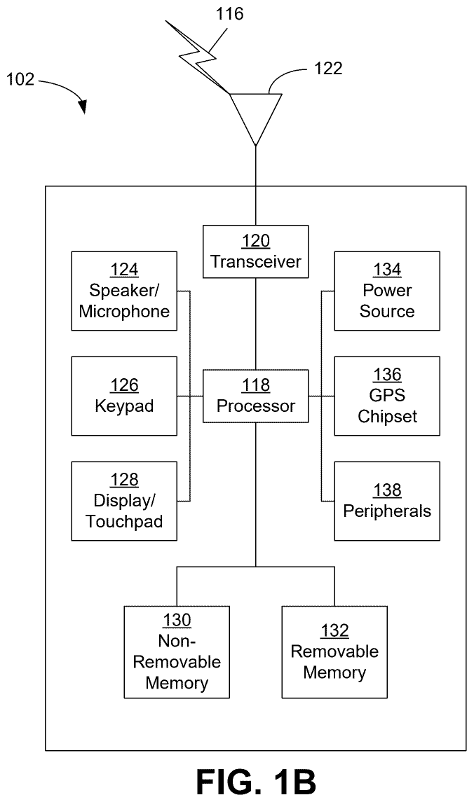

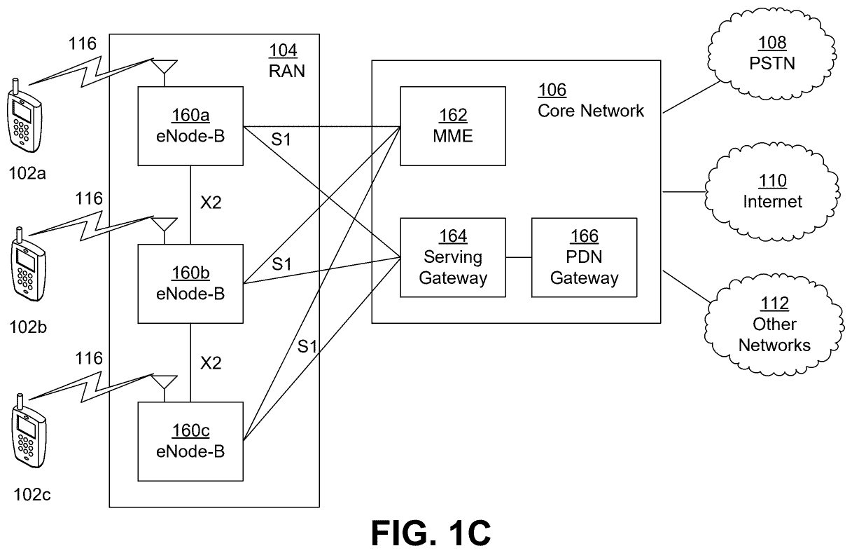

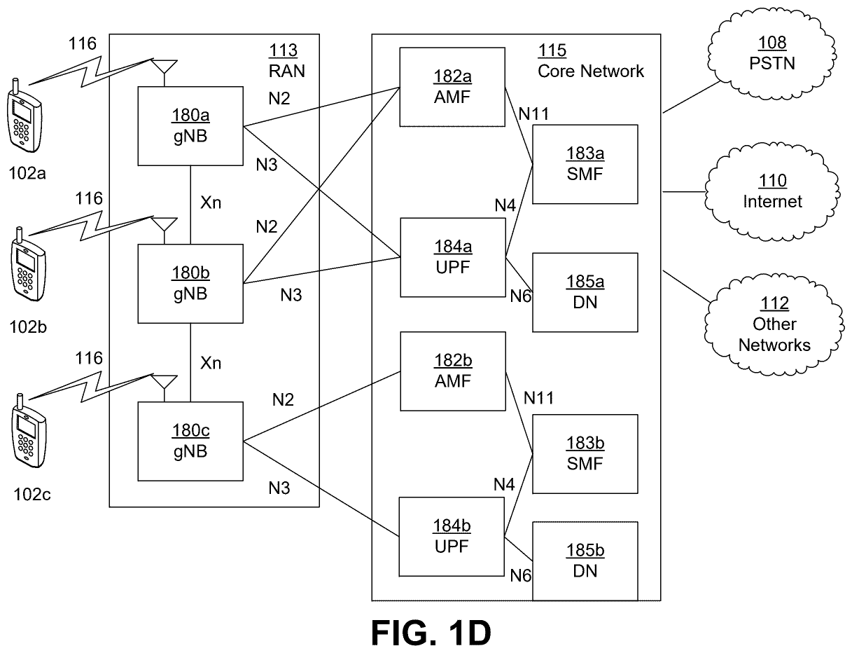

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The existing 5G channel state information (CSI) framework uses four different types of references (e.g., time-domain symbol indices) for CSI-RS reception, CSI determination, and CSI reporting. These references are summarized as follows.

The CSI reference resource reference is summarized as follows. For a reporting slot n′, the CSI reference resource is a downlink slot (e.g., a slot with index n where n′ in time is after n or where n′ has a larger integer value as compared to n). The WTRU may report a CSI after receiving at least one CSI-RS occasion no later than the CSI reference resource or no later than the CSI reference resource slot. Otherwise, the WTRU may drop the report.

The point D reference is summarized as follows. Point D is defined as a symbol which is Z′ symbols before the first symbol of UL carrying the CSI report. When the CSI-RS resources are P or AP and the CSI reporting is AP, the WTRU is not expected to measure a CSI when the CSI-RS is received after point D.

When the CSI-RS resource is AP and the CSI reporting is also AP, the WTRU may ignore the scheduling downlink control information (DCI) if no hybrid automatic repeat request (HARQ) acknowledgement (ACK) or transport block is scheduled or multiplexed on the physical uplink shared channel (PUSCH) and the first symbol of uplink starts before Z_{ref}, where Z_{ref} is the next uplink symbol with its cyclic prefix (CP) starting T_{poc,CSI} time-units after the last time-unit of physical downlink control channel (PDCCH), where T_{poc,CSI} is defined in terms of time-units, starting from the last time unit of the downlink transmission (e.g., PDCCH that includes DCI) triggering the CSI report.

When the CSI-RS resource is AP and the CSI reporting is also AP, the WTRU may ignore the scheduling downlink control information (DCI) if the number of triggered reports is one and no HARQ-ACK or transport block is scheduled or multiplexed on the PUSCH, when the first symbol of uplink starts before

$${Z}_{ref}^{′} , where {Z}_{ref}^{′}$$

is the next uplink symbol with its CP starting

$${T}_{poc , CSI}^{′}$$

is defined in terms of time-units, starting from the last time unit of the CSI-RS resource used for determining a CSI

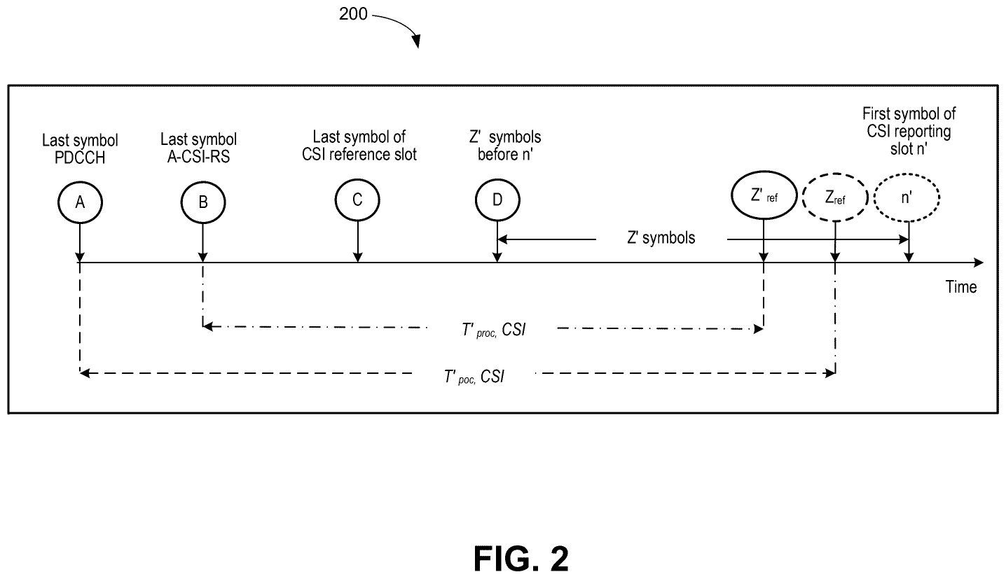

Examples of WTRU behaviors in terms of CSI-RS reception, CSI determination, and CSI reporting detailed above are also shown in FIG. 2. FIG. 2 shows examples of CSI-RS reception, CSI determination, and CSI reporting based on the CSI timeline at 200.

The existing CSI framework and the associated WTRU behaviors are very rigid (e.g., not flexible enough or not adaptive) in terms of the CSI timeline. Stated another way, the existing CSI framework is rigid in terms of CSI-RS reception and the follow-up WTRU behavior(s) or WTRU processing(s) of the reference signal (RS) (e.g., CSI-RS) for CSI determination and reporting. For example, the existing CSI framework restricts the WTRU in providing valuable CSI information to the gNB. For instance, when the WTRU receives a CSI-RS resource after the reference resource slot, the WTRU may drop the CSI report. However, a more capable WTRU (e.g., capable in terms of computational power) may be able to determine a valid full CSI or a valid partial CSI even when a CSI-RS resource is received after the reference resource. A more capable WTRU can also prepare the UL transmission (e.g., PUCCH or PUSCH) for reporting of the CSI, but instead it drops the CSI report due to the restrictions of the existing CSI framework.

This disclosure present solutions intended to make the CSI framework much more flexible, adaptive, and/or smart. These solutions allow a WTRU to make efficient use of valuable resources (e.g., computational resources and time/frequency resources) and report a CSI that is useful to the gNB for the follow-up downlink transmissions to the WTRU.

The proposed solutions are contemplate introducing one or more reference(s) or reference point(s). For example, one or more reference symbol(s) may be introduced between the last symbol of the downlink transmission (e.g., DCI in a PDCCH) triggering the CSI-RS resource(s) and triggering the CSI reporting and the first symbol of uplink carrying the CSI report (e.g., the first symbol of PUCCH or PUSCH) and the first symbol of a time window for which the WTRU determines the CSI. Based on one or more of the last symbol(s) of CSI-RS, the reference symbols, and/or the first symbol of the uplink transmissions carrying the CSI report, the WTRU can dynamically change different parameters (e.g., report quantity).

In examples, when the CSI timeline is violated, the WTRU may decide to determine a report quantity that is different from the gNB configured report quantity. For example, the WTRU may not have sufficient time resources and/or computational resources to determine the configured report quantity. Instead, the WTRU may determine a new report quantity different than the report quantity configured by the gNB. For example, the WTRU may be configured to determine and report rank indication (RI) and precoding matrix indicator (PMI), but instead, the WTRU may determine only the RI.

In examples, the WTRU may dynamically change sub-bands: For example, the WTRU may not determine a CSI for one or more (e.g., all) of the sub-bands. The WTRU may determine a CSI for a subset of sub-bands.

The definition of, “CSI timeline violation” is considered herein. The terms “CSI timeline violation” or “timeline violation” as used herein may refer to one or more of the conditions, situations, or states discussed below.

A CSI timeline violation or timeline violation may occur when the last time unit (e.g., last symbol) associated with a DL RS (e.g., CSI-RS) reception is later (e.g., is after) than one or more reference unit(s) (e.g., reference time unit(s)) in the first set of reference unit(s). A first set of reference time unit(s) is explained in detail and with examples provided in the paragraphs below. For example, a CSI timeline violation or timeline violation may occur when the last symbol of CSI-RS is after the last symbol of the CSI reference resource slot.

A CSI timeline violation or timeline violation may occur when the first time unit (e.g., the first symbol) of UL transmission (e.g., first symbol of PUCCH or PUSCH) carrying the CSI report starts earlier than one or more reference unit(s) in the first set of reference unit(s). For example, a CSI timeline violation or timeline violation may occur when the first symbol of UL carrying the CSI report starts earlier than the symbol index(es) identified by Z_{ref} and/or

$${Z}_{ref}^{′}$$

### in FIG. 2.

A CSI timeline violation or timeline violation may occur when the last time unit (e.g., the last symbol) of DL RS is received later than one or more reference unit(s) in the first set of reference unit(s). The reference time unit(s) in the first set of time unit(s) may be measured and/or may be placed a threshold number of time unit(s) earlier than the first time unit of UL carrying the CSI report.

In examples, a CSI timeline violation or timeline violation may occur if the reference time unit is defined as a time instance (e.g., symbol, slot, sub-slot, frame, sub-frame, CP index, etc.) starting Z instances earlier than the first symbol of PUCCH or PUSCH. In examples, a CSI timeline violation or timeline violation may occur when the last symbol of CSI-RS is received after point D. An example of point D is provided in FIG. 2.

A CSI timeline violation or timeline violation may occur when the computational resources of a WTRU dedicated for determination of a CSI for a frequency unit (e.g., component carrier (CC), bandwidth(s), bandwidth part(s), sub-band(s)) and/or time unit (e.g., a duration of time or a time window, a number of symbols, slots, frames, sub-frames) are busy, not available, or are occupied by another computational task.

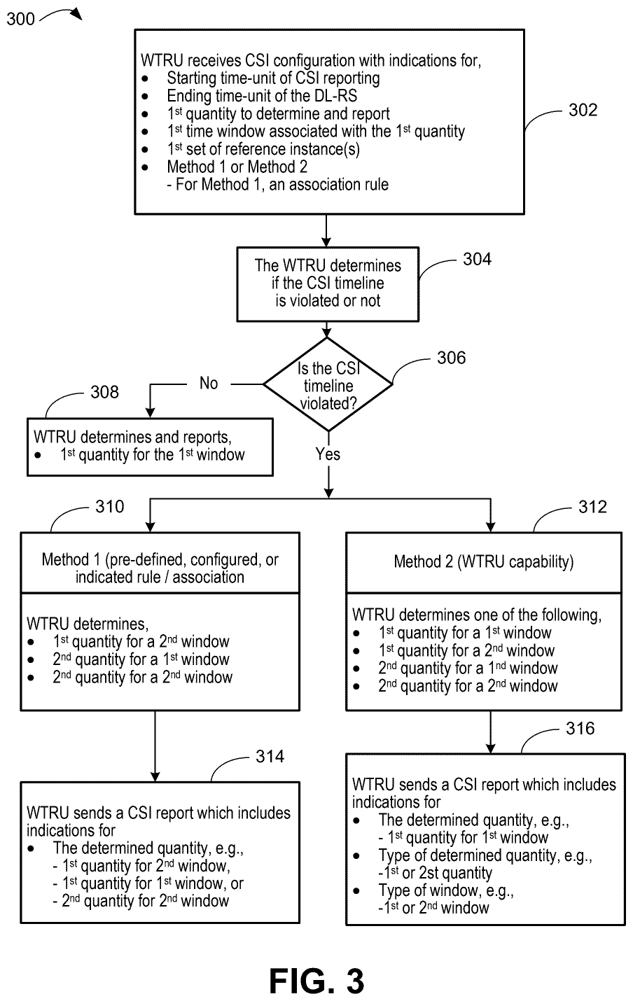

FIG. 3 depicts a flow chart showing an example of a procedure for a flexible CSI framework at 300. Example procedures for flexible CSI are discussed below. A WTRU and/or network entity configured for flexible CSI may perform one or more of the following steps.

At 302, the WTRU may receive a CSI configuration. The CSI configuration may include indications for one or more of the following.

The CSI configuration may include an indication of a last DL instance (e.g., time symbol or time slot) of a reference signal (RS). The CSI configuration may include an indication of a starting instance (e.g., time symbol or time slot) of the uplink transmission carrying the CSI report.

The CSI configuration may include an indication of a first quantity to determine and report. The first quantity may comprise a plurality of component quantities. For example, the first quantity may comprise a first precoder, where the first precoder comprises a number, N₄, of component-precoders. The first precoder may be denoted as PMI₁=[PMI_{c1}, PMI_{c2}, . . . , PMI_{cN}_{₄}].

The CSI configuration may include an indication of a first time window associated with the first quantity. The first time window may be partitioned into a plurality of sub-windows and where each sub-window is associated with a component quantity of the first quantity. For example, the first time window has a quantity, N₄, of sub-windows. Each sub-window may be associated with a component quantity of the first quantity.

The CSI configuration may include an indication of a first set of reference instance(s). The first set of reference instance(s) may include one or more reference instances. The reference instances may be defined between the last instance of the DL transmission triggering the CSI report and the first instance of the time window.

The CSI configuration may include an indication of a method for determining the CSI. For example, the CSI configuration may indicate whether method 1 or method 2 should be used for determining the CSI.

When method 1 is configured, a rule to determine a first or a second quantity for a first or a second time window. The rule may be based on the first set of reference instance(s), the starting instance of UL carrying the CSI report, the last instance of DL RS and/or a second set of reference instance(s). The second set of reference instance(s) may include one or more reference instance(s). The second set of reference instance(s) may, in examples, be defined or placed between the last instance of the DL transmission triggering the CSI report and the first instance of the first time window.

The WTRU that receives the CSI configuration may be configured to perform one or more of the following steps.

At 304 the WTRU may determine whether or not the CSI timeline is violated. The WTRU may determine to take different actions based on its determination that the CSI timeline is or is not violated at 306. At 308, the WTRU may determine a first quantity for the first time window (e.g., if the CSI timeline is not violated). In examples, the WTRU may determine the first quantity for the first time window when the last instance of DL RS is before a first reference instance in the first set of reference instance(s) and/or the first instance of UL carrying the CSI report is after the second reference instance in the first set of reference instance(s) symbols.

The WTRU may perform one or more of the following steps. In examples, the WTRU may be configured to perform one or more of the following steps when the last instance of DL RS is after the first reference instance in the first set of reference instance(s) and/or the first UL instance carrying the CSI report is before the second reference instance in the first set of reference instance(s).

The WTRU may be configured to determine a first quantity for the second time window (e.g., as shown in FIG. 3; method 1 at 310, method 2 at 312). For example, the WTRU may determine N₄ component quantities for a second time window with N₄ sub-windows. One or more sub-windows may have a smaller number of time instances as compared to the number of instances configured for the corresponding sub-window in the first time window. The WTRU may determine component quantities for a second time window based on the configured rule or association when method 1 is configured and autonomously when method 2 is configured.

The WTRU may may be configured to determine a second quantity for the first time window (e.g., as shown in FIG. 3; method 1 at 310, method 2 at 312). For example, the WTRU may determine a second quantity for the first time window wherein the determined second quantity is based on one or more of the following: a reduced number of CSI-RS antenna ports, sub-bands, sub-windows, transmit receiving points (TRPs), a duration of a sub-window, time and frequency domain compression parameters. The WTRU may determine the second quantity for the first time window based on the configured rule or association when method 1 is configured and autonomously when method 2 is configured.

The WTRU may may be configured to determine a second quantity for the second time window (e.g., as shown in FIG. 3; method 1 at 310, method 2 at 312). For example, the WTRU may determine a second quantity for a second time window, wherein the second quantity is based on one or more of the following: a reduced number of CSI-RS antenna ports, sub-bands, TRPs, and/or time and frequency domain compression parameters. The second time window may have a reduced number of sub-windows and/or a reduced number of symbols in one or more sub-windows as compared to the first time window. The WTRU may determine the second quantity for the second time window based on the configured rule or association when method 1 is configured and autonomously when method 2 is configured.

The WTRU may send a CSI report (e.g., as shown in FIG. 3; method 1 at 314, method 2 at 316). The CSI report may include indications for the determined first and/or second quantity for a first or second window. In examples, when method 2 is configured for determination of the CSI, the CSI report may also include one or more of the following. The CSI report may include an indication that a first and/or second quantity is/are being reported for a 1st or 2nd time window.

Additionally, or alternatively, the WTRU may perform one or more of the following steps. The WTRU may receive a CSI configuration. The CSI configuration may include indications for one or more of the following.

The CSI configuration may include an indication of a first report quantity to determine and report (e.g., RI-PMI-Wideband CQI-Sub-band CQI). The CSI configuration may include an indication of a slot index and symbol index of the last symbol of downlink (DL) reference signal (RS). In examples, the last symbol of CSI-RS may be denoted as a.

The CSI configuration may include an indication of a slot index and symbol index of the first symbol of uplink channel carrying the CSI report. In examples, the first symbol of PUCCH or PUSCH carrying the CSI report may be a+y. The CSI configuration may include an indication of a slot index and/or symbol index of one or more reference symbols. In examples, the first reference symbol may be a+X₁. The second reference symbol may be a+X₂, and so on.

The CSI configuration may include an indication of an association between different report quantities, slot and/or symbol index of the last symbol of DL RS, slot and/or symbol index of the first symbol of UL carrying the CSI report, and/or the reference symbol(s).

The WTRU may be configured to perform one or more of the following actions. The WTRU may determine a first report quantity. In examples, the WTRU may determine the first report quantity when the first symbol of UL carrying the CSI report has an index higher than the first reference symbol and/or the second reference symbol.

The WTRU may select a report quantity. In examples, the WTRU may select the report quantity based on an association between report quantities and the index of the first symbol of UL carrying the CSI report. The first report quantity may comprise rank, PMI, wideband CQI, and/or sub-band CQIs. The first symbol of UL carrying the CSI report may have an index.

The index of the first symbol of UL carrying the CSI report may be higher than the index of the first reference symbol, the second reference symbol, and the third reference symbol. In such cases, the WTRU may select a report quantity which comprises rank, PMI, wideband CQI and/or sub-band CQIs.

The index of the first symbol of UL carrying the CSI report may be higher than the index of the first reference symbol and the second reference symbol but lower than the index of the third reference symbol. In such cases the WTRU may select a report quantity which comprises rank, PMI, and/or wideband CQI.

The index of the first symbol of UL carrying the CSI report may be higher than the index of the first reference symbol but lower than the index of the second reference symbol and third reference symbol. In such cases, the WTRU may select a report quantity which comprises rank, and/or PMI.

The WTRU may select a (sub) set of some or all of the sub-bands from the set of sub-bands for determination of a report quantity. The WTRU may select the (sub) set of sub-bands based on an association between (sub) sets of sub-bands and index of the first symbol of UL carrying the CSI report.

In examples, the set of sub-bands may include subband1, subband2 . . . subband10.

In examples, when the index of the first symbol of UL carrying the CSI report is higher than the first reference symbol, second reference symbol, and third reference symbol, the WTRU may select one or more (e.g., all) of subband1 through subband10 for determination of the report quantity.

In examples, when the index of the first symbol of UL carrying the CSI report is higher than the first reference symbol and second reference symbol but lower than the third reference symbol, the WTRU may select a subset of subband1 through subband10. For example, the WTRU may select the odd or even numbered sub-bands for determination of the report quantity.

In examples, when the index of the first symbol of UL carrying the CSI report is higher than the first reference symbol and lower than the second and third reference symbol, the WTRU may select a subset of subband1 through subband10. For example, the WTRU may select one third of the sub-bands for determination of the report quantity.

The WTRU may determine a report quantity. The determined report quantity may be associated with the selected sub-bands.

The WTRU may send a CSI report. The CSI report may include the determined report quantity and/or the index of the first symbol of uplink channel carrying the CSI report.

The solutions discussed herein may be extended to the cases of high Doppler CSI, CRI based CSI, CSI for network energy savings, and faster Scell activation, as discussed below in greater detail.

In examples, instead of dropping the determination and reporting of a valid, updated, or new CSI when a CSI timeline violation occurs, the WTRU may determine a valid, updated, or new full or partial CSI using a pre-defined, configured, or indicated rule or association (e.g., as in method 1 operation) or autonomously using the WTRU capability (e.g., as in method 2 operation).

The WTRU may be configured to perform the actions or steps necessary, so that when a CSI timeline violation happens, the WTRU can determines a second CSI based on a pre-defined, configured, or indicated rule, or autonomously using its capability.

A benefit of the solutions contemplated herein is that: the WTRU may provide a valid full or a valid partial CSI to the gNB which is useful for the wireless link estimation between the WTRU and the gNB.

Throughout this disclosure, ‘a’ and ‘an’ and similar phrases may be interpreted as ‘one or more’ or ‘at least one.’ Similarly, any term which ends with the suffix ‘(s)’ is to be interpreted as ‘one or more’ or ‘at least one.’ The term ‘may’ should usually be interpreted as meaning ‘may, for example.’

A symbol ‘/’ (e.g., forward slash) may be used herein to represent ‘and/or.’ For example, ‘A/B’ may imply ‘A and/or B’.

The terms TRP, MTRP, and M-TRP may be used interchangeably herein. Throughout this disclosure, a TRP (e.g., transmission and reception point) may be interchangeably used with one or more of TP (transmission point), RP (reception point), RRH (radio remote head), DA (distributed antenna), BS (base station), a sector (of a BS), and/or a cell (e.g., a geographical cell area served by a BS). Herein, Multi-TRP may be interchangeably used with one or more of MTRP, M-TRP, and multiple TRPs.

A WTRU may report a subset of channel state information (CSI) components. CSI components may correspond to one or more of the following: a CSI-RS resource indicator (CRI), a SSB resource indicator (SSBRI), an indication of a panel used for reception at the WTRU (e.g., such as a panel identity or group identity), measurements such as L1-RSRP, L1-SINR taken from SSB or CSI-RS (e.g. cri-RSRP, cri-SINR, ssb-Index-RSRP, ssb-Index-SINR), and/or other channel state information such as at least rank indicator (RI), channel quality indicator (CQI), precoding matrix indicator (PMI), Layer Index (LI), and/or the like.

Herein, the term “signal” may be interchangeably used with any one or more of following: Sounding reference signal (SRS), Channel state information-reference signal (CSI-RS), Demodulation reference signal (DM-RS), Phase tracking reference signal (PT-RS), Synchronization signal block (SSB).

Throughout this disclosure, a channel may be interchangeably used with one or more of following: Physical downlink control channel (PDCCH), Physical downlink shared channel (PDSCH), Physical uplink control channel (PUCCH), Physical uplink shared channel (PUSCH), Physical random access channel (PRACH), etc.

Herein, the terms quantity, report quantity, and/or channel state information (CSI) may be interchangeably used with one or more of following: Rank indicator (RI), Precoding matrix indicator (PMI), Channel quality indicator (CQI), Wideband channel quality indicator (WCQI), Sub-band channel quality indicator (SCQI), Wideband precoding matrix indicator (i1), Layer indicator (LI), CSI reference resource index (CRI), Signal to noise and interference ratio (SINR), Reference signal received power (RSRP), etc.,

Herein, the term downlink reception may be used interchangeably with Rx occasion, PDCCH, PDSCH, and/or SSB reception.

Herein, the term uplink transmission may be used interchangeably with Tx occasion, PUCCH, PUSCH, PRACH, and/or SRS transmission.

Herein, the term RS may be interchangeably used with one or more of RS resource, RS resource set, RS port and/or RS port group.

Herein, the term RS may be interchangeably used with one or more of SSB, CSI-RS, SRS and/or DM-RS.

Herein, the terms time instance or time-unit may be interchangeably used with slot, symbol, and/or subframe.

Herein, the terms frequency instance or frequency unit may be interchangeably used with subcarrier, resource element (RE), sub-band, band, and/or bandwidth part.

Herein, the terms CSI reference slot, CSI reference resource, CSI reference resource slot, and/or reference slot may be interchangeably used.

Herein, the terms prediction, determination, calculation, and/or estimation may be used interchangeably.

Herein, the term CSI processing unit (CPU) may refer to the computational resource(s) used to determine a CSI report.

Herein, the term full or full quantity may refer to the CSI quantity configured by the gNB, and partial or partial quantity may refer to a CSI quantity determined by the WTRU that is different from the CSI quantity configured by the gNB.

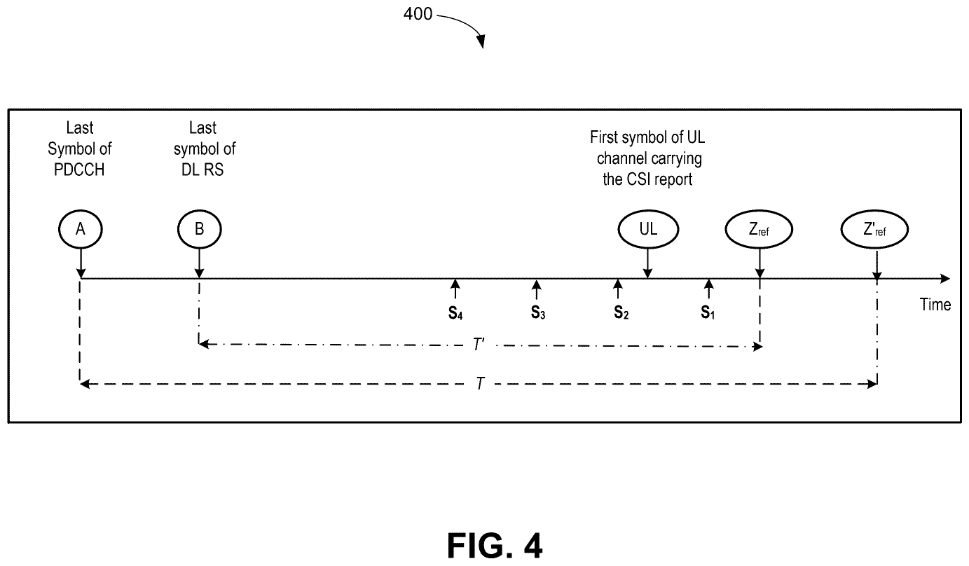

At 400, FIG. 4 shows a timing diagram showing an example of an application involving a periodic CSI-RS and periodic CSI reporting. In examples (e.g., as shown in FIG. 4) a WTRU may use an association rule (e.g., as in Tables 1, Table 2, and/or Table 3).

For example, in FIG. 4, the WTRU may receive a PDCCH transmission. The PDCCH transmission may comprise a DCI that triggers a CSI report. The WTRU may receive a CSI-RS for determination of the CSI report. The WTRU may receive a first set of reference unit(s) (e.g., Z_{ref} and

$${Z}_{ref}^{′} ) .$$

The WTRU may receive a symbol index of the first time-symbol. The first symbol index may indicate where (e.g., when) the uplink transmission should begin. In examples, the symbol index may indicate where the reporting of the determined CSI should begin. In the example shown in FIG. 4, the first symbol of uplink transmission carrying the CSI is before the two reference unit(s) (e.g., Z_{ref} and

$${Z}_{ref}^{′} )$$

in the first set of reference units and it the CSI timeline is violated. As per the existing NR specifications, since the CSI timeline is violated, the WTRU will ignore the scheduling DCI and will not determine and report a CSI.

As discussed herein, the WTRU may receive a second set of reference unit(s), where the second set of reference units may include one or more reference units (e.g., as shown by s₁, s₂, s₃, and s₄ in FIG. 4). The WTRU may also receive an association rule. The association rule may be based on the second set of reference units. Examples of such association rules are shown or provided in Table 1, Table 2, and Table 3. Based on such association rule(s), the WTRU may determine a valid, updated, or new CSI and report it to the gNB (e.g., in PUCCH or PUSCH).

In examples, the gNB may configure a report quantity that includes RI, PMI, W-CQI, and/or S-CQI. The WTRU may report the configured report quantity, (e.g., RI, PMI, W-CQI, and/or S-CQI) when (e.g., only when) the uplink transmission where the CSI is to be reported starts after the first set of reference units. Additionally, or alternatively the WTRU may report the configured report quantity when (e.g., only when) the CSI timeline is not violated.

In examples, the uplink transmission may be configured to start earlier than the first set of reference units. In examples, the uplink transmission may start between the first unit (e.g., s₁) and the second unit (e.g., s₂) in the second set of reference units. In such a case, the WTRU may use (e.g., when configured) an association rule (e.g., as detailed in Table 1) to determine a second report quantity (e.g., RI, PMI, and/or W-CQI). The WTRU may ignore or may not determine S-CQI. After determining the second report quantity, the WTRU may report the second report quantity on the allocated uplink resources in configured uplink transmission.

Additionally, or alternatively, when a CSI timeline violation occurs or happens, the WTRU may determine a full valid CSI or partial valid CSI. In examples, the WTRU may determine the full or partial valid CSI by borrowing occupied or busy CPUs from another computational task (e.g., CPUs that occupied to determine a CSI in another bandwidth part) or by borrowing unoccupied CPUs from a set of CPUs. The WTRU may include one or more indicators in the CSI report to indicate to the gNB that a full valid CSI was determined and is being reported even though CSI violation occurred. For example, the CSI report may include a first indicator to indicate to the gNB that the determined CSI is valid and a second indicator to indicate to the gNB that the determined and/or reported CSI is full, partial, or a previously reported CSI quantity.

Details on association rules are discussed herein. In examples, one or more association rule(s) may be defined, pre-defined, or determined based on one or more of the following parameters discussed below. The one or more association rules may be defined, pre-defined, or determined based on a configured report quantity (e.g., RI, PMI, W-CQI, S-CQI, CRI, i1, etc.).

The one or more association rules may be defined, pre-defined, or determined based on a second set of reference symbols. The one or more association rules may be defined, pre-defined, or determined based on a first set of reference time units and/or frequency units. The one or more association rules may be defined, pre-defined, or determined based on a second set of reference time units and/or frequency units. The one or more association rules may be defined, pre-defined, or determined based on a number of subsets in the second set of time units and/or frequency units.

The one or more association rules may be defined, pre-defined, or determined based on a number of TRPs. The one or more association rules may be defined, pre-defined, or determined based on a number of sub-bands. The one or more association rules may be defined, pre-defined, or determined based on a number of CPUs and/or the WTRU's computational capability.

The one or more association rules may be defined, pre-defined, or determined based on a separation (e.g., in terms of time units between the last time unit of the first set of time units and the first time unit of the second set of time units. The one or more association rules may be defined, pre-defined, or determined based on a separation in terms of frequency units between the last frequency unit of the first set of frequency units and the first frequency unit of the second set of frequency units. The one or more association rules may be defined, pre-defined, or determined based on a number of component carriers.

The one or more association rules may be defined, pre-defined, or determined based on a number of bandwidth parts. The one or more association rules may be defined, pre-defined, or determined based on a number of component precoders (e.g., N₄). The one or more association rules may be defined, pre-defined, or determined based on a number of time unit(s) and/or frequency unit(s) (e.g., the number of time symbols and/or sub-bands that are associated with one or more component precoders).

The one or more association rules may be defined, pre-defined, or determined based on a subcarrier spacing of the CSI-RS resource(s), DL transmission(s) and/or UL transmission(s). The one or more association rules may be defined, pre-defined, or determined based on a number of CSI-RS antenna port panels. The one or more association rules may be defined, pre-defined, or determined based on a number of codewords in a codebook or number of spatial domain basis in a codebook of spatial domain basis.

The one or more association rules may be defined, pre-defined, or determined based on a codebook type. The one or more association rules may be defined, pre-defined, or determined based on a type of RS (e.g., SSB, CS-RS, SRS, PTRS, DM-RS). The one or more association rules may be defined, pre-defined, or determined based on a mode of the RS (e.g., P CSI-RS, SP CSI-RS, A CSI-RS). The one or more association rules may be defined, pre-defined, or determined based on a parameter, setting, or event occurring.

Table 1 shows an example association rule. The example association rule shown in Table 1 is defined using the following parameters: A first set of reference time units (e.g., symbol indexes Z_{ref} and

$${Z}_{ref}^{′} ) ;$$

a second set of reference time units (e.g., symbol indexes denoted by s₁, s₂, s₃ and s₄); report quantities; and the index of the first symbol of UL carrying the CSI report.

Table 2 shows another example association rule. The example association rule in Table 2 is defined using the following parameters: A first set of reference time units (e.g., Z_{ref} and

$${Z}_{ref}^{′} ) ;$$

a second set of reference time units (e.g., symbol indexes denoted by s₁, s₂, s₃ and s₄); sub-bands; and an index of the first symbol of UL carrying the CSI report.

In examples, an association rule may be linked to a one or more of parameters discussed herein that may be used to define an association rule.

For example, the WTRU may receive a configuration of a report quantity (e.g., RI, PMI, WCQI, and/or SCQI). The configured report quantity may be associated with an association rule. For example, the configured report quantity may be associated with the association rule in Table 1. In the event of a CSI timeline violation, the WTRU may use the association rule (e.g., as shown in Table 1) to determine a partial or component report quantity.

Examples of association rules are discussed herein.

Table 1, Table 2, and Table 3 illustrate examples of association rules. In Table 1, the association is defined based on a first set of reference time units (e.g., Z_{ref} and

$${Z}_{ref}^{′} ) ,$$

a second set of reference time units (e.g., s₁, s₂, s₃, s₄ and four different report quantities).

For example, when the association rule in Table 1 is configured and the CSI timeline violation occurs such that the first time unit of uplink transmission denoted by UL may be between two reference time units, (e.g., UL is between the reference symbols S₁ and S₂). The WTRU may be configured to report quantities, RI, i1, WCQI, and/or SCQI. However, the WTRU may determine a report quantity RI-i1-WCQI.

For example, when the association rule in Table 2 is configured and the CSI timeline violation occurs such that the first time unit of uplink transmission denoted by UL may be between two reference time units, (e.g., UL is between the reference symbols S₁ and S₂, S₂<UL<S₁). The WTRU may be configured to report quantities RI, i1, WCQI, SCQI for one or more (e.g., all) configured sub-bands. The WTRU may determine a report quantity RI, i1, SCQI but only for every third sub-band (e.g., only for the third, sixth, ninth and so on sub-bands).

Table 1 shows an example of association between a first set of reference symbols, a second set of reference symbols, the first symbol of UL carrying the CSI report, and the report quantities.

TABLE 1

| UL symbol index | Report Quantity | |
|---|---|---|
| UL > (Z_{ref} and Z′_{ref}) | RI − PMI − | Configured by the gNB |
| | WCQI − SCQI | |
| S₁ < UL < (Z_{ref} and Z′_{ref}) | RI − PMI − WCQI | Determined by the |
| S₂ < UL < S₁ | RI − i1 − WCQI | WTRU |
| S₃ < UL < S₂ | RI − i1 | |
| S₄ < UL < S₃ | RI | |

Table 2 shows an example of association between a first set of reference symbols, a second set of reference symbols, the first symbol of UL carrying the CSI report, and frequency units (e.g., sub-bands).

TABLE 2

| UL symbol | Sub-bands for CSI determination | |
|---|---|---|
| UL > (Z_{ref} and | All configured sub-bands | Configured |
| Z′_{ref}) | | by the gNB |
| S₁ < UL < (Z_{ref} | Even or odd numbered sub-bands, | Determined |
| and Z′_{ref}) | (e.g., sub-bands with indices 1, 3, 5 | by the WTRU |
| | and so on or sub-bands with indices | |
| | 2, 4, 6 and so on) | |
| S₂ < UL < S₁ | Every 3^{rd} sub-band, (e.g., sub-bands | |
| | with indices 3, 6, 9, and so on) | |
| S₃ < UL < S₂ | Every 4^{th} sub-band, (e.g., sub-bands | |
| | with indices 4, 8, 12 and so on) | |

Table 3 shows an example of association between a first set of reference symbols, a second set of reference symbols, the first symbol of UL carrying the CSI report, frequency units (e.g., sub-bands, and report quantities).

TABLE 3

| UL symbol | | Sub-bands for CSI | |
|---|---|---|---|
| index | Quantity | determination | |
| UL > (Z_{ref} and | RI − PMI − | All sub-bands | Configured |
| Z′_{ref}) | WCQI − SCQI | | by the gNB |
| S₁ < UL < (Z_{ref} | RI − PMI − | Even or odd sub-bands | Determined |
| and Z′_{ref}) | WCQI − SCQI | | by the WTRU |
| S₁ < UL < (Z_{ref} | RI − PMI − | Every 3^{rd} sub-band | |
| and Z′_{ref}) | WCQI − SCQI | | |
| S₁ < UL < (Z_{ref} | RI − PMI − | All sub-bands | |
| and Z′_{ref}) | WCQI | | |
| S₂ < UL < S₁ | RI − PMI − | Even or odd sub-bands | |
| | WCQI | | |
| S₃ < UL < S₂ | RI − i1 | All sub-bands | |

The first and second set of reference units are discussed herein.

In examples, one or more parameters that may be used to define the association rule (e.g., as in Table 1, Table 2, and/or Table 3), may also be used to define one or more of the following units.

One or more parameters that can be used to define the association rule may be used to define the first set of reference time unit(s) and/or frequency unit(s) (e.g., the number of time and/or frequency units and the index(es) of the time and/or frequency units in the first set of units).

One or more parameters that can be used to define the association rule may be used to define the second set of reference time unit(s) and/or frequency unit(s) (e.g., the number of time and/or frequency units and the index(es) of the time and/or frequency units in the second set of units).

In examples, the number of units and the indexes of units in the first and/or the second set of units may be defined or determined as discussed herein.

The number of units and the indexes of units in the first and/or the second set of units may be fixed. The number of units and the indexes of units may be defined as fixed.

For example, in the first and/or second set of time symbols, the numbers of symbols may be fixed such that there are G₁ symbols when the CSI-RS is periodic, G₂ symbols when the CSI-RS is aperiodic, and G₃ symbols when the CSI-RS is semi-persistent.

For example, in the first and/or second set of time symbols, the numbers of symbols may be fixed such that there are M₁ symbols when the CSI reporting is periodic, M₂ symbols when the CSI reporting is aperiodic, and M₃ symbols when the CSI reporting is semi-persistent.

For example, in the first and/or second set of time symbols, the numbers of symbols may be fixed such that there are G₄ time symbols when the CSI-RS is periodic and the CSI reporting is also periodic, G, time symbols when the CSI-RS is periodic and the CSI reporting is semi-persistent, and G₆ time symbols when the CSI-RS is periodic and the CSI reporting is aperiodic.

In examples, the indexes of the time symbols in the second set of time symbols may be equally spaced. The number of units and the indexes of units in the first and/or the second set of units may be determined based on a rule. The number of units and the indexes of units may be defined, derived, or determined based on a rule (e.g., based on an equation, where the rule may consider one or more parameters used to define the association rule(s), as illustrated in Table 1, Table 2, and/or Table 3).

For example, the number of time symbols in the first and/or second set is determined based on the candidate number of report quantities (e.g., the candidate number of report quantities in Table 1 is 5 and in Table 3 is 6.). Therefore, number of time symbols in the second set of time symbols is equal to the number of candidate report quantities or the number of candidate sub-bands.

For example, the WTRU may derive the indices of time symbols in the first and/or second set of time symbols based on the number of time symbols between the last symbol of downlink transmission that includes the DCI that triggers the CSI report and the first symbol of UL where the CSI report is to be transmitted and the number of candidate report quantities and/or other parameters.

In examples, the indexes of the time symbols in the first and/or second set of time symbols may be equally spaced between the last symbol of PDCCH that contains the DCI which triggers resources and reporting of the CSI report and the first symbol of UL where the CSI is to be reported.

UE behaviors based on configured CSI association rules are discussed herein.

In examples, a WTRU may transmit (e.g., to a base station (BS), a gNB, a TRP, etc.) WTRU-capability information associated with CSI. The WTRU-capability information may indicate one or more maximum supported parameter values (e.g., or a value range) for one or more CSI association rules. The maximum value(s) (e.g., or value range) may be reported based on one or more parameter(s) for determining a CSI association rule discussed herein (e.g., Z_{ref},

$${Z}_{ref}^{′} ,$$

supported report quantity combination(s), and/or supported subband combination(s) and granularities, etc.).

In examples, the supported report quantity combination(s) may comprise a first set of one or more lists. Each list of the first set of one or more lists may represent one or more report components (e.g., “RI-PMI-WCQI-SCQI”, “RI-PMI-WCQI”, “RI-i1-WCQI”, “RI-i1”, etc., as shown in examples based on Tables 1 and 3). The WTRU may report one or more side information bit(s), indicating a priority level and/or a ranking indicator across the first set of one or more lists. For example, the highest priority level and/or ranking indicator may be associated with the highest WTRU complexity, with priority level and or ranking decreasing along with complexity, such that the lowest ranking indicator is associated with the lowest WTRU complexity. Complexity may be in terms of measuring, deriving, and/or reporting a CSI, for example.

In examples, the WTRU may report the side information indicating that a list such as, “RI-PMI-WCQI-SCQI,” is associated to require higher (e.g., the highest) WTRU complexity and/or more (e.g., the most) CSI processing time duration.

In examples, the supported subband combination(s) and/or granularities may comprise a second set of one or more lists. Each list of the second set of one or more lists may represent one or more subband-related components (e.g., “All (configured) sub-bands”, “Even or odd sub-bands”, “Every n-th sub-band”, etc., as shown in examples based on Tables 2 and 3). The WTRU may report one or more side information bit(s), indicating a priority level and/or a ranking indicator across the second one or more lists. In examples, the highest priority level and/or ranking indicator may be associated with the highest WTRU complexity, with priority level and/or ranking decreasing along with complexity, such that the lowest priority level and/or ranking indicator is associated with the lowest WTRU complexity. Complexity may be in terms of measuring, deriving, and/or reporting a CSI including one or more subband CSI components, for example.

In examples, the WTRU may report the side information indicating a list of “All (configured) sub-bands” is associated with (e.g., requires) the highest WTRU complexity and/or the most CSI processing time duration. In an example, the first set of one or more lists and the second set of one or more lists may be jointly comprised (e.g., in a joint list or a list of lists). A list of one or more joint lists may represent one or more report components and/or subband-related components. The report components and/or subband-related components may be associated with the side information indicating a priority level and/or a ranking indicator across the joint lists.

In examples, the WTRU may receive (e.g., from a base station (BS), a gNB, a TRP, etc.) configuration information for one or more CSI association rules. In examples, the configuration information for the CSI association rules may be based on the reported WTRU-capability information. An association rule of the one or more CSI association rules may be comprised based on one or more reported parameter(s) (e.g., such as Z_{ref},

$${Z}_{ref}^{′} ) ,$$

supported report quantity combination(s), and/or supported subband combination(s) and granularities, etc., as shown in examples based on Tables 1, 2, 3).

In examples, the WTRU may receive a control command (e.g., via a MAC-CE and/or a DCI). The control command may indicate one or more association rules to be updated with another association rule and/or to be reconstructed with a different applicable combination of report quantities. The control command may indicate one or more subbands, (e.g., sub-bands as illustrated in the association example presented in Table 2. The WTRU may be configured to transmit a confirmation message (e.g., ACK, a new UCI type, a new signaling format, etc.) for a successful reception of the control command in response to receiving the control command. To report a CSI, for periodic and/or semi-persistent CSI, or for a triggered aperiodic CSI, the WTRU may be configured to determine an applicable combination of report components and/or one or more subbands with a determined subband granularity. The WTRU may be configured to determine the applicable combination of report components and/or the one or more subbands with a determined subband granularity, based on a given condition on the CSI processing timeline.

In examples, the WTRU may determine that, for a given CSI reporting instance, a condition for a violation (e.g., collision, triggering an exceptional behavior, etc.) is met. In such cases, the WTRU may determine that the condition for a violation is met based on one or more of the CSI association rules. The WTRU may determine (e.g., when the CSI timeline is violated) to send a report (e.g., to a gNB, base station, etc.).

At least one report quantity may be dropped from a report (e.g., when the CSI timeline is violated or when CSI payload exceeds a configured threshold, or when the CSI payload cannot be fit into the allocated uplink resources for CSI reporting). At least one report quantity may be reported by using a previously reported CSI quantities (e.g., if a given CSI timeline exceeds the WTRU's capability based on the reported WTRU-capability information). In examples, the WTRU may determine to drop a quantity and/or report a quantity using a previously reported CSI quantity based on an association between reference symbols and the first symbol of UL. In examples, the WTRU may report a new PMI and a new (e.g., current, updated) CQI, but the WTRU may report an RI (and/or i1) which was previously reported (e.g., in the most recent CSI reporting instance or the latest CSI reporting instance which corresponds to the same CSI configuration). In examples, the WTRU may report new (e.g., current or updated) CQIs on (e.g., only on) sub-bands with odd indexes, while previously reported CQIs (e.g., CQIs which were reported at the most recent CSI reporting instance which corresponds to the same CSI configuration) are reported on the corresponding sub-bands with even indexes.

Examples of applications involving CRI based CSI are discussed herein. For example, high Doppler and prediction CSI are discussed herein.

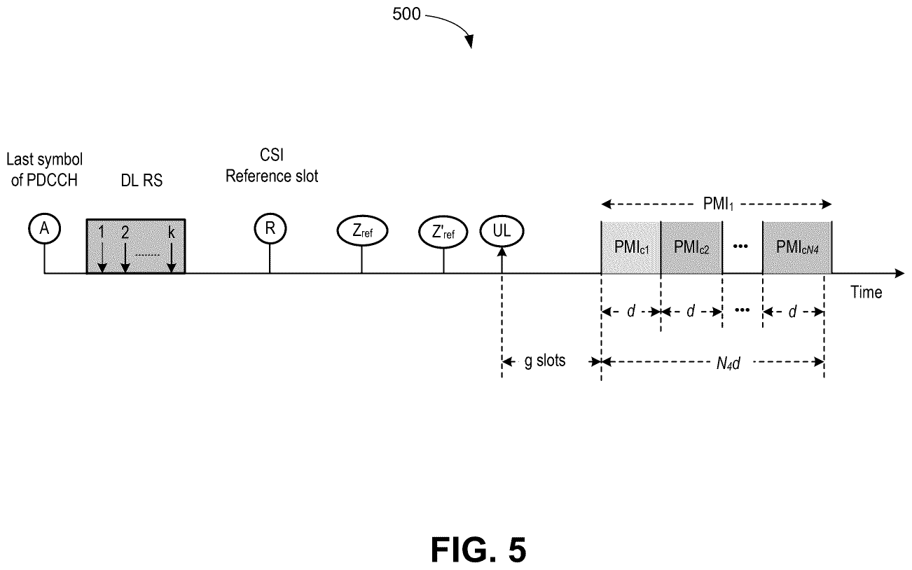

FIG. 5 shows an example timeline at 500, highlighting high Doppler CSI enhancement when aperiodic CSI-RS resources are used for determining a CSI.

Enhancements to enhanced Type-II (eType-II) and further enhanced port-selection Type-II (feType-II) codebook can support accurate CSI in high Doppler use cases. Specifically, enhancements were introduced to the DL RS (e.g., CSI-RS) for CSI determination and the time window associated with the determined CSI. Some systems support periodic CSI-RS (P CSI-RS), semi persistent CSI-RS (SP CSI-RS), and aperiodic CSI-RS (A CSI-RS) as reference signal resources for determining, calculating, or predicting a CSI for a reporting window. The reporting window is portioned into multiple sub windows. The number of sub-windows in the reporting window is N₄. N₄ may also be termed as the number of Doppler domain basis. The duration (in time) of each window is d slots. Thus duration (e.g., in time) of the reporting window is N₄ d time units. The reporting window is g slots after the last symbol of uplink transmission carrying the determined CSI report (e.g., the last symbol of PUSCH).

The WTRU behavior in terms of whether to determine a full valid CSI, an updated CSI or ignore the scheduling DCI depends on the following: The type of CSI-RS resources (e.g., whether the CSI-RS resources are periodic, semi-persistent, or aperiodic); and/or one or more reference symbols.

The one or more reference symbols may depend on the type of the CSI-RS resources, (e.g., if the CSI-RS resources are periodic, semi-persistent, or aperiodic). These reference symbols may be the same as the references explained more thoroughly herein.

For example, in FIG. 5, the WTRU may receive a PDCCH that contains a DCI field that triggers A CSI-RS resources for CSI measurement. The A CSI-RS resource may be up to 32 port CSI-RS resources. The CSI-RS resource may be repeated K times with a time unit offset between each repetition. In examples, the DCI triggers a burst of A-CSI-RS resources with K transmission occasions by the gNB and/or K reception occasions by the WTRU. For example, a WTRU may report a CSI when (e.g., only when) the first symbol where the uplink (UL) transmission(s) begin is after the reference symbols Z_{ref} and

$${Z}_{ref}^{′} .$$

When the resources are SP-CSI-RS and P-CSI-RS, the WTRU behavior in terms of CSI determination and reporting may be the same as explained herein.

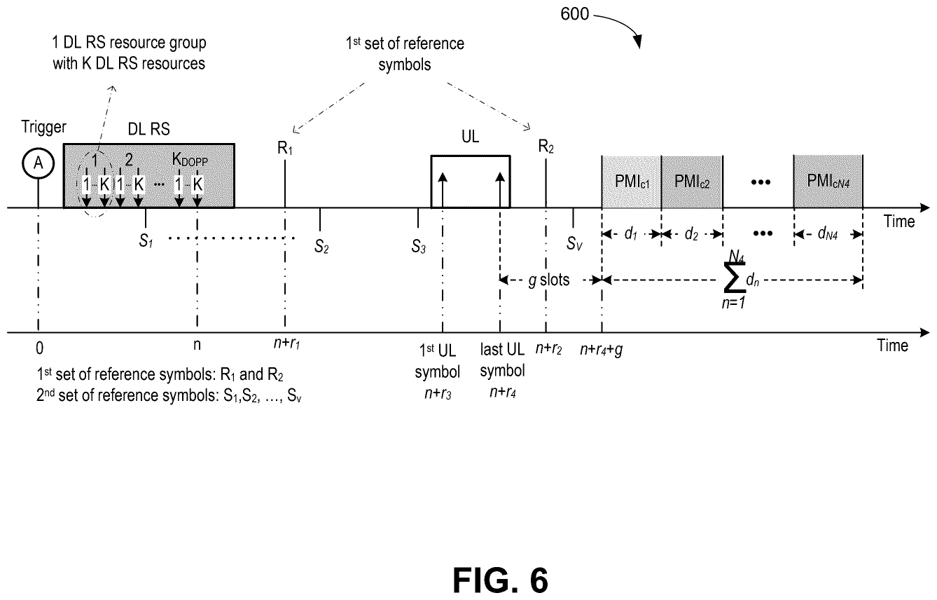

FIG. 6 shows an example highlighting high Doppler CSI enhancements at 600. The high Doppler CSI may be extended from up to 32 CSI-RS antenna ports to up to 128 CSI-RS antenna ports. The gNB may configure a CSI-RS resource set. The CSI-RS resource set may contain one or more CSI-RS resource groups. Each CSI-RS resource group may have one or more CSI-RS resources. Each CSI-RS resource in a CSI-RS resource group may be up to 32 ports. Up to 128 ports may be aggregated across one or more (e.g., all) of the CSI-RS resources in a CSI-RS resource group. In some examples, CSI may have up to 32 CSI-RS antenna ports precoder. However, high Doppler CSI enhancements can determine up to 128 CSI-RS antenna ports precoder and/or CSI for the reporting window.

WTRU configurations are discussed herein. A WTRU may semi-statically and/or dynamically receive a DL RS configuration. The DL RS configuration may include indications for one or more of the following items.

The DL RS configuration may include indications for the number of DL RS resource groups in a DL RS resource set. For example, the CSI-RS resource set may have K_DOPP number of CSI-RS resource groups.

The DL RS configuration may include indications for the number of DL RS resource(s) or DL RS reception occasion(s) in each DL RS resource group in the DL RS resource set. For example, each of the K_DOPP CSI-RS resource group(s) may have K number of CSI-RS resources or CSI-RS reception occasions.

The DL RS configuration may include indications for index(es) of antenna ports at the transmitter associated with a DL RS resource in a DL RS resource group. For example, the first 32 CSI-RS antenna ports at the gNB may be associated with a first CSI-RS resource in one or more CSI-RS resource groups in the CSI-RS resource set. In examples, the 1 to 32 antenna ports may be associated with the first CSI-RS resource in each of the K_DOPP CSI-RS resource groups in the CSI-RS resource set. In examples, the 33 to 64 antenna ports may be associated with the second CSI-RS resource in each of the K_DOPP CSI-RS resource groups in the CSI-RS resource set. In examples, the 65 to 96 antenna ports may be associated with the third CSI-RS resource in each of the K_DOPP CSI-RS resource groups in the CSI-RS resource set.

The DL RS configuration may include indications for index(es) of one or more time unit(s) and/or one or more frequency unit(s) that may be used or that are being used for at least one of the following applications.

The index(es) of one or more time units and/or one or more frequency units may be used for transmission of one or more DL RS resource(s) by the transmitter. In examples, a first time unit(s) and a first frequency unit(s) may be used for transmission of the first CSI-RS resource in a first CSI-RS resource group in the first CSI-RS resource set. In examples, a second time unit(s) and a second frequency unit(s) may be used for transmission of the second CSI-RS resource in a first CSI-RS resource group in the first CSI-RS resource set.

The index(es) of one or more time units and/or one or more frequency units may be used for reception of one or more DL RS resource(s) by the receiver. In examples, a first time unit(s) and a first frequency unit(s) may be used for reception of the first CSI-RS resource in a first CSI-RS resource group in the first CSI-RS resource set. In examples, a second time unit(s) and a second frequency unit(s) may be used for reception of the second CSI-RS resource in a first CSI-RS resource group in the first CSI-RS resource set.

The DL RS configuration may include indications for separation in terms of time unit(s) and/or frequency unit(s) between two or more DL RS resources and/or two or more DL RS reception occasion(s) of a DL RS resource group.

For example, the CSI-RS resource set may have two CSI-RS resource groups. The first resource group may have 4 CSI-RS resources or 4 CSI-RS reception occasions. The WTRU may receive an indication of separation in terms of time units and/or frequency units between two consecutive (e.g., the first and second) CSI-RS resources and/or the first and second CSI-RS reception occasions.

The DL RS configuration may include indications for separation in terms of time units and/or frequency units between the last DL RS resource or DL RS reception occasion of a first DL RS resource group and the first DL RS resource or DL RS reception occasion of a second DL RS resource group. For example, the WTRU may receive an indication of separation in terms of time units between the last CSI-RS resource of the first resource group and the first CSI-RS resource of the second CSI-RS resource group in the CSI-RS resource set.

The DL RS configuration may include indications for an index of the last time unit and/or frequency unit of the last DL RS resource or the last DL RS reception occasion of the last DL RS resource group in a DL RS resource set. For example, the last CSI-RS resource group may be K_{DOPP} and have K CSI-RS resources or K CSI-RS reception occasions. The WTRU may receive the index of the time unit of the Kth CSI-RS reception occasion in the K_{DOPP}th resource group. For example, the index of the time unit of the Kth CSI-RS reception occasion in the K_{DOPP}th resource group may be denoted n.

The DL RS configuration may include indications for a first set of reference time unit(s) and/or reference frequency unit(s) and/or the number of reference time unit(s) and/or frequency unit(s) in the first set of reference time unit(s) and/or frequency unit(s). For example, the first set of reference time unit(s) may include two reference symbols. The first reference symbol may be n+r₁. The second reference symbol may be n+r₂.

The DL RS configuration may include indications for a first set of time-units and/or frequency units where the first set of time unit(s) and/or frequency unit(s) may include one or more time unit(s) and/or frequency unit(s) that may be used by the WTRU for reporting the determined CSI.

In examples, the first symbol of uplink transmissions carrying the CSI report may be n+r₃ and the last symbol of uplink transmissions carrying the CSI report may be n+r₄. In examples, the first symbol of uplink transmission may be n+r₃−1 and the first symbol of uplink transmission where the CSI reporting begins may be n+r₃. In examples, the last symbol of uplink transmission may be n+r₄+2 and the last symbol of uplink transmission where the CSI reporting ends may be n+r₄.

The DL RS configuration may include indications for a second set of time unit(s) and/or frequency unit(s). The second set of time unit(s) and/or frequency unit(s) may have one or more of the following characteristics.

The second set of time unit(s) and/or frequency unit(s) may be divided or partitioned into one or more of subset(s) of time unit(s) and/or frequency unit(s). For example, the second set has N₄ subsets.

Each subset of time unit(s) and/or frequency unit(s) may include one or more time units and/or frequency unit(s).

Each subset of time units and/or frequency units may have the same or a different number of time unit(s) and/or frequency unit(s). For example, the number of symbols in the first subset may be d₁. For example, the number of symbols in the N₄th subset may be d_{N4}.

Each subset of time units and/or frequency units may be associated with a component quantity, component report quantity, partial quantity, and/or fractional quantity.

In examples, a first component PMI (e.g., PMI (1) may be associated with a first subset of time unit(s) and/or frequency unit(s). A second component PMI (e.g., PMI_{c2}) may be associated with a second subset of time unit(s) and/or frequency unit(s).

In examples, the WTRU may determine a first component PMI (e.g., PMI_{c1}) for the time unit(s) and/or frequency unit(s) that are associated with the first subset of time unit(s) and/or frequency unit(s).

The DL RS configuration may include indications for a separation in terms of time unit(s) and/or frequency unit(s) between the last time unit and/or frequency unit of the first set of time unit(s) and/or frequency unit(s) and the first time unit and/or frequency unit of the second set of time unit(s) and/or frequency unit(s).

In examples, the separation may be in terms of a number of slots denoted g. For example, the separation between the last symbol of the first set of symbols and the first symbol of the second set of symbols may be g slots.

The DL RS configuration may include indications for a second set of reference time unit(s) and/or frequency unit(s). The second set of time units and/or frequency units may have one or more of the following characteristics.

The second set of reference time unit(s) and/or frequency unit(s) may include one or more time unit(s) and/or frequency unit(s). For example, the second set of reference time unit(s) may comprise a number of time unit(s) denoted by ν (e.g., s₁, . . . , s_{ν}).

The reference time unit(s) of the second set of reference time unit(s) may be defined between the last time unit of DL transmission triggering the DL RS resources for CSI measurement and the first time unit of uplink transmission where the determined CSI is reported.

The DL RS configuration may include indications for a method of operation. For example, the DL RS configuration may indicate whether method 1 or method 2 should be used. In examples, method 1 may be configured for a first bandwidth part and method 2 may be configured for a second bandwidth part.

The DL RS configuration may include indications for one or more association rule(s).

CSI determination is discussed herein.

In examples, when the CSI timeline violation happens or the CSI timeline violation occurs, the WTRU may perform one or more of the following actions.

The size of the reporting window used to determine CSI may be changed (e.g., by the WTRU). The WTRU may determine a CSI (e.g., the configured report quantity but for a second reporting window). The second reporting window may be based on one or more of the following conditions.

The second reporting window may have a smaller number of time unit(s) and/or smaller number of sub-windows as compared to the first reporting window. The second reporting window may have the same number of sub-windows as the first reporting window. Similarly, the number of time-unit(s) and/or frequency unit(s) in the second reporting window may be less than or the same as the number of time-units and/or frequency units in the first reporting window.

In examples, the second reporting window may have both smaller and fewer time units than the first reporting window. In examples, the second reporting window may have time units of the same size as the first reporting window, but the second reporting window may have fewer time units. In examples, the second time unit may have the same number of time and/or frequency resources as the first time unit, but the size of the time units may be smaller for the second reporting window.

In examples, one or more sub-windows in the second reporting window may have a smaller number of time unit(s) and/or frequency unit(s) as compared to first reporting window.

For example, instead of determining a number, N₄, of component precoders for the N₄ sub-windows in the first reporting window, the WTRU, may determine a second number, N₃, of component precoders for a second reporting window that has N₃ number of sub-windows using a configured, indicated, or fixed association rule (e.g., the one in Table 4) determines N₃.

For example, instead of determining N₄ number of component precoders for the N₄ number of sub-windows in the first reporting window, where one or more of the sub-window(s) in the first set of reporting window has a first duration (e.g., the ith sub-window in the first reporting window has dᵢ number of time symbols), the WTRU may determine N₄ number of component precoders for the N₄ number of sub-windows in a second reporting window. One or more of the sub-windows in the second reporting window may have a second duration (e.g., the ith sub-window in the second reporting window may have eᵢ number of time symbols). The second duration of a sub-window in a second reporting window may be smaller than the first duration of a sub-window in a first reporting window (e.g., dᵢ may be smaller than eᵢ or

$${\sum }_{i = 1}^{{N}_{4}} {d}_{i} > {\sum }_{i = 1}^{{N}_{4}} {e}_{i} ) .$$

The position of the reporting window may be changed (e.g., changed to a third reporting window). The WTRU may determine a CSI for a third reporting window. The third reporting window may be based on one or more of the following,

The third reporting window may have the same number of time-unit(s), frequency unit(s), and/or sub-windows as the first reporting window or the second reporting window. However, the starting and/or the ending time unit(s) and/or the starting and/or ending frequency unit(s) of the third reporting window may be different than the first reporting window or the second reporting window.

For example, the third reporting window may have the same number of sub-windows, the same number of time symbol, and/or the same number of sub-bands as the first reporting window. However, the third reporting window may start earlier in time and/or in frequency as compared to the first reporting window.

For example, the first reporting window may start at time symbol n+r₄+g. The WTRU may determine a CSI for a third reporting window that starts at time symbol n+r₄+f₁ (e.g., where g₁<g or g₁ is smaller than g).

The report quantity may be changed (e.g., from the first report quantity to a second report quantity). The WTRU may determine a second report quantity for the first reporting window, for the second reporting window, or for the third reporting window. The second report quantity may be a reduced variant, reduced version, or reduced form of the first report quantity.

In examples, the first report quantity may include two CQI values whereas the second report quantity may be based on a single CQI value.

In examples, the first report quantity may include a PMI (e.g., PMI₁) which is based on N₄ component PMIs (e.g., PMI₁=[PMI_{c1}, . . . , PMI_{cN}_{₄}]). Each of the component PMIs may be a 128 CSI-RS antenna port PMI. The second report quantity may include a PMI (e.g., PMI₂) which is based on N₃ number of component PMIs (e.g., PMI₂=[PMI_{c1}, . . . , PMI_{cN}_{₃}]) N₃ may be less than N₄. Each of the component PMI associated with the second report quantity may be a 64 CSI-RS antenna port PMI.

Table 4 illustrates an example of an association rule based on the following: A first set of reference symbols, e.g., Z_{ref} and

$${Z}_{ref}^{′} ;$$

a second set of reference symbols, e.g., s₁, s₂, s₃, s₄; report quantity (e.g., RI, PMI, CQI); sub-bands to consider for CSI determination; components PMIs to determine (e.g., all component PMIs N₄); separation in terms of time units (e.g., denoted by the column separation g in Table 4), between the last symbol of uplink and first symbol of the reporting window.

In examples, the WTRU may receive a CSI configuration to determine and report a quantity, (e.g., RI, PMI, and CQI) for a reporting window that has one or more (e.g., all) of the configured sub-windows (e.g., all the configured N₄ sub-windows). The report quantity (e.g., the PMI) may be based on the configured number of component PMIs (e.g., N₄ component PMIs). The reporting windows may begin g slots starting from the last symbol of the uplink carrying the CSI report where the configured value of g is g=1 slot.

As part of the CSI configuration, the WTRU may also receive a configuration of an association rule, (e.g., as seen in the example shown in Table 4). When the uplink begins after both the Z_{ref} and

$${Z}_{ref}^{′}$$

time reference symbols in the first set of reference symbols, the WTRU may determine the configured report quantity for the configured reporting window. When the uplink transmission occurs between the first reference symbol (e.g., s₁) and the earliest reference symbol in the first set of reference symbols, the WTRU may determine the configured report quantity for a reporting window that is based on one or more (e.g., all) of the configured sub-bands. The WTRU may determine the configured report quantity for a subset of the configured bands (e.g., only the even numbered component sub-bands of the configured reporting window) and where the reporting window begins one or more (e.g., five) symbols after the last symbol of the uplink transmission.

Table 4 shows an example of an association rule between the first symbol of UL carrying the CSI report, the reference symbols, the report quantities, sub-bands, and the component PMIs.

TABLE 4

| UL symbol | Report | Sub-bands for CSI | | |
|---|---|---|---|---|
| number | Quantity | determination | Component PMIs | Separation g |
| UL > (Z_{ref} and Z′_{ref}) | RI, PMI, CQI | All sub-bands | All component PMIs | g = 1 slot |
| S₁ < UL < (Z_{ref} and Z′_{ref}) | RI, PMI, CQI | All sub-bands | Even numbered component PMIs | g = 5 symbols |
| S₂ < UL < S₁ | RI, PMI | All sub-bands | Odd numbered component PMIs | g = 3 symbols |
| S₃ < UL < S₂ | RI, PMI | Even numbered sub-bands | Even numbered component PMIs | g = 2 symbols |
| S₄ < UL < S₃ | RI, i1 | Odd numbered sub-bands | Odd numbered component PMIs | g = 0 symbols |

CSI reporting is discussed herein. In examples, the WTRU may send a CSI report to the gNB using uplink transmission(s) (e.g., PUCCH or PUSCH). Method 1 may be configured for CSI determination. Method 1 may be based on a gNB configured or indication association rule (e.g., Table 1, Table 2, Table 3, Table 4, or Table 5). The CSI report may include the determined report quantities. Method 2 may be configured for CSI determination. When the WTRU uses method 2 for CSI determination, the WTRU may include additional indicator in the CSI report to indicate to the gNB that the determined CSI is full or partial.

The WTRU may include an indicator in the CSI report. In examples, the indicator may indicate that even though the CSI timeline was violated, the WTRU determined the configured report quantity for the configured reporting window. In examples, that the indicator may indicate that even though the CSI timeline was violated, the WTRU determined a second report quantity for a second reporting window. In examples, the indicator may indicate that instead of the configured quantities (e.g., RI, PMI, CQI) the WTRU determined a second set of quantities (e.g., RI, PMI).

Multi-TRP CSI is discussed herein. A WTRU may be configured to report a CSI for an mTRP hypothesis. The WTRU may also be configured for an association rule (e.g., Table 5).

In examples, the WTRU may determine a CSI for (e.g., only for) TRPs that have channel measurements resources (CMRs) which satisfy the reference points Z_{ref} and Z′_{ref}. This may be referred to as a “no violation condition” herein.

In examples, a subset, N′_{TRP}, of the TRPs may satisfy the no violation condition, where N′_{TRP}=N_{TRP}. In such cases, the WTRU may determine a report quantity (e.g., RI, PMI, WCQI, and/or SCQI) for one or more (e.g., all) sub bands for those N′_{TRP} TRPs.

In examples, the WTRU may determine a CSI for (e.g., only for) those N′_{TRP} TRPs that satisfy no violation condition. The WTRU may select a subset of the other (N_{TRP}−N′_{TRP}) TRPs.

For example, the WTRU may (e.g., randomly) select a subset of TRP(s) from the set of (N_{TRP}−N′_{TRP}) TRPs to determine a CSI for them. In such cases, since the violation happens for the selected TRP(s), the WTRU may determine a partial report quantity for the selected subset of TRPs, based on WTRU capability or a configured association rule.

In examples, the WTRU may determine a mechanism to select a subset of TRP(s) from the set of (N_{TRP}−N′_{TRP}) TRPs to determine a (e.g., full) CSI for them. That mechanism can be related to one or more reference points. For example, the WTRU may pick up one or more TRPs from the (N_{TRP}−N′_{TRP}) TRPs that have CMRs satisfy a condition such as the following condition:

$${S}_{1} < UL < ( {Z}_{ref} and {Z}_{ref}^{′} ) .$$

In examples, the WTRU may first pick up M_{TRP} TRPs from N_{TRP} TRPs based on the RSRP. The WTRU may then determine a report quantity based on reference point violations of each TRP.

For example, the WTRU may select the M_{TRP} TRPs that have RSRPs that are the best among N_{TRP} TRPs. the value of M_{TRP} may be configured through RRC, where M_{TRP}<N_{TRP}. The WTRU may determine whether the no violation condition is satisfied for those M_{TRP} TRPs.

In examples, if there are

$${M}_{TRP}^{′}$$

TRPs that satisfy the no violation condition, the WTRU may perform one or more of the following actions.

The WTRU may determine a CSI with a report quantity including one or more (e.g., all) of RI, PMI, WCQI, and/or SCQI for one or more (e.g., all) sub bands for those M′TRP TRPs.

The WTRU may determine a partial CSI with a report quantity for those

$$( {M}_{TRP} - {M}_{TRP}^{′} )$$

TRPs. The report quantity may comprise one of the following quantities.

The report quantity may comprise RI, PMI, WCQI and/or SCQI for some of the sub bands. These sub bands may be configured for the WTRU through RRC. Additionally, or alternatively, the WTRU may determine based on an association rule which sub bands should be considered for the report quantity determination. The report quantity may comprise RI, PMI and/or WCQI. The report quantity may comprise RI, a flag for PMI, and a flag for WCQI to indicate to the gNB to employ the previously reported PMI and WCQI.

In examples, the WTRU may determine a new report quantity (e.g., instead of the configured report quantity). The new report quantity may be similar to the configured report quantity (e.g., the configured report quantity is RI, PMI, CQI and the new report quantity is RI, PMI, CQI). However, the new report quantity may be based on a reduced number or a subset of sub-bands.

In examples, the WTRU may be configured with a threshold for the number of sub bands,

$${N}_{sub}^{th} < {N}_{sub} ,$$

where N_{sub} is the total number of sub bands. Then, based on this threshold, the WTRU may determine a report quantity including at least

$${N}_{sub}^{th}$$

CQIs to report for

$${N}_{TRP}^{′}$$

TRPs that satisfy the no violation condition, as discussed more fully below.

If WTRU is configured to report at least

$${N}_{sub}^{th} and {N}_{sub}^{th} < \frac{{N}_{sub}}{2} ,$$

the report quantity may include CQIs for a subset (e.g., only the even or odd) sub-bands. If WTRU is configured to report at least

$${N}_{sub}^{th} and {N}_{sub}^{th} < \frac{{N}_{sub}}{2} ,$$

the WTRU may randomly select

$${N}_{sub}^{th}$$

sub bands to calculate CQIs or the WTRU may calculate all CQI for N_{sub} sub bands and select the best

$${N}_{sub}^{th}$$

sub bands for the report quantity.

In examples, the WTRU may be configured with one or more (e.g., two) thresholds. A first threshold may be for the number of sub bands,

$${N}_{sub}^{th} < {N}_{sub} ,$$

where N_{sub} is the total number of sub bands. A second threshold may be for the minimum separation in terms of frequency units

$$( e . g . , {M}_{sub}^{th} ) .$$

In examples, the secund threshold may be used to set a minimum number of subbands between two subbands selected by the WTRU for CSI determination (e.g., for a report quantity determination).

In some scenarios (e.g., such as time varying channels) the channel varies fast. Therefor, the gNB may be configured to determine that the report of at least

$${N}_{sub}^{th}$$

that has a minimum of the configured separation.

Based on

$${N}_{sub}^{th} and / or {M}_{sub}^{th} ,$$

the WTRU may determine a report quantity by performing one or more of the following actions.

In examples, the WTRU may select sub bands with

$$[ \frac{{N}_{sub}}{{M}_{sub}^{th}} ]$$

sub bands with

$${M}_{sub}^{th}$$

distance from

$${N}_{s u b}^{th}$$

sub band. Then, the WTRU may (e.g., randomly) select the other

$${N}_{s u b}^{th} - [ \frac{{N}_{s u b}}{{M}_{s u b}^{th}} ]$$

sub bands from the

$${N}_{s u b} - [ \frac{{N}_{s u b}}{{M}_{s u b}^{th}} ]$$

remaining sub bands.

In examples, the WTRU may select

$$[ \frac{{N}_{s u b}}{{M}_{s u b}^{th}} ]$$

sub bands with

$${M}_{s u b}^{th}$$

distance from

$${N}_{s u b}^{th}$$

sub bans. The WTRU may then select the first

$${N}_{s u b}^{th} - [ \frac{{N}_{s u b}}{{M}_{s u b}^{th}} ]$$

sub bands from the

$${N}_{s u b} - [ \frac{{N}_{s u b}}{{M}_{s u b}^{th}} ]$$

remaining sub bands.

The number of TRPs is considered herein. In examples, the WTRU may determine a new report quantity based on the number and scenario (e.g., operation mode) of TRP(s).

In examples, if N_{TRP}>1 and multi TRPs are in coherent joint transmission (CJT) mode, the WTRU may determine a joint PMI for one or more (e.g., all) the TRPs. In some cases, the WTRU may determine a joint PMI for (e.g., for only) the TRPs having channel measurements resources (CMRs) that do not violate the CSI timeline. The WTRU may determine a separate PMI for the TRP(s) having CMRs that violate the CSI timeline. Additionally, or alternatively, the WTRU may be configured with a threshold for the number of TRPs

$$( {N}_{T R P}^{th} )$$

to report a joint PMI. The joint PMI may be for the configured threshold number of TRPs.

In another solution, WTRU may be configured with a threshold for the number of TRP(s) (N_{TRP}th) so that WTRU select

$${N}_{T R P}^{th}$$

TRP(s) will the highest RSRP values. Then WTRU may determine a report quantity (e.g., RI, PMI, WCQI and SCQI) for one or more (e.g., all) sub bands for the

$${N}_{T R P}^{th}$$

TRP(s) and a second report quantity (e.g., including RI, PMI, WCQI) for the remaining

$${N}_{T R P} - {N}_{T R P}^{th}$$

In a solution, a WTRU may be configured to report a precoder for N TRPs. The precoder may indicate information including one or more of the following: a. spatial domain basis per TRP; a spatial domain basis per TRP group; a frequency domain compression basis per TRP; a frequency domain compression basis per TRP group; a time domain compression basis per TRP; and/or a time domain compression basis per TRP group.

When a CSI timeline violation for one or more of the TRPs occurs (e.g., when the CSI-RS resources associated with one or more TRPs violates the CSI timeline), the WTRU may perform one or more of the following actions.

The WTRU may determine a spatial domain basis per TRP group. The WTRU may determine the spatial domain basis per TRP group instead of determining a spatial domain basis per TRP (e.g., when configured to report spatial domain basis per TRP).

The WTRU may determine a frequency domain basis per TRP group. The WTRU may determine the frequency domain basis per TRP group instead of determining a frequency domain basis per TRP (e.g., when configured to report frequency domain basis per TRP).

The WTRU may determine time domain basis per TRP group. The WTRU may determine the time domain basis per TRP group instead of determining a time domain basis per TRP (e.g., when configured to report time domain basis per TRP).

Uplink resources for CSI reporting are considered herein. The WTRU may determine a new report quantity based on the available uplink resources.

In examples, if the WTRU is configured to report CSI and the CSI report is multiplexed with uplink data transmission (e.g., piggyback PUSCH), the WTRU may determine a partial CSI (e.g., a CSI for a TRP group). The WTRU may add dummy data in the uplink transmission to match the payload size of the uplink transmission. Additionally or alternatively, the WTRU may include additional indicators in the CSI report. The additional indicators may indicate TRP indexes that can be interpreted by the gNB as TRP indexes for the previously reported PMI.

In examples, the WTRU may prioritize the TRPs, and report (e.g., only report) a partial CSI from the high priority TRP(s).

Time available for CSI and data packaging is discussed herein. In some examples (e.g., involving a large number of TRPs, sub-bands, ports, etc.), additional time, other than the time required for CSI determination may be needed for UCI packaging. When the UCI packaging time is limited, the WTRU may determine a partial CSI so that enough time is available for the WTRU to complete packaging the determined CSI and data for uplink transmission.

Table 5 shows an example of an association rule between the first symbol of UL carrying the CSI report, the reference symbols, the report quantities, sub-bands, and TRPs.

| | | Sub-bands | |
|---|---|---|---|
| | | for CSI | |
| UL symbol number | Report Quantity | determination | TRP |
| UL > (Z_{ref} and Z′_{ref}) | RI − PMI − | All sub-bands | All TRPs |
| | WCQI − SCQI | | |
| S₁ < UL < (Z_{ref} and | RI − PMI − | Even or odd | All TRPs |
| Z′_{ref}) | WCQI − SCQI | sub-bands | |
| S₂ < UL < S₁ | RI − PMI − WCQI | All sub-bands | Subset, e.g., |
| | | | 1^{st}, 2^{nd} TRP |
| S₃ < UL < S₂ | RI − PMI | Even or odd | All TRPs |
| | | sub-bands | |

Aggregated CSI-RS resources-based CSI is discussed herein. The number of CSI-RS antenna ports supported in some examples is up to 32 ports. However, some examples may extend the number of CSI-RS ports from 32 ports to up to 128 CSI-RS antenna ports. The measurement resources (e.g., the CSI-RS resources) are configured in the form of a set (e.g., CSI-RS resource set). The CSI-RS resource set may have multiple CSI-RS resources and the CSI-RS antenna ports are spread across the CSI-RS resources in the CSI-RS resource set. In examples, a CSI-RS resources set may have up to 4 CSI-RS resources.

Each CSI-RS resource in the CSI-RS resource set may be up to 32 CSI-RS antenna ports. For example, in the CSI-RS resource set, the first resource may be mapped to the first 32 ports (e.g., CSI-RS resource1 is based on CSI-RS antenna ports with indexes 1 to 32). The second resource may be mapped to the second 32 ports (e.g., CSI-RS resource2 is based on CSI-RS antenna ports with indexes 33 to 64).

CSI determination is considered herein. The gNB may share one or more CSI-RS resources with one or more (e.g., two) WTRUs. For example, the gNB may configure a first WTRU that only supports up to 32 CSI-RS ports and a second WTRU that can support up to 128 CSI-RS ports to measure and report a CSI using the same CSI-RS resource.

In examples, the gNB may transmit a first CSI-RS resource at a time unit t₁ (e.g., a first slot) and at a frequency unit f₁ (e.g., a first sub-band). The gNB may transmits a second CSI-RS resource at time unit t₂ (e.g., a second slot) and at a frequency unit f₂ (e.g., a second sub-band). The first WTRU and/or the second WTRU may know (e.g., both may be configured by the gNB to know) that the first CSI-RS resource is to be received at a first time unit t₁ and at a first frequency unit f₁ and/or that the second CSI-RS resource is to be received at a second time unit t₂ and at a second frequency unit f₂.

The first WTRU may monitor the frequency unit f₁ at the time unit t₁ to receive the CSI-RS for CSI determination. In examples, when a CSI timeline violation happens or occurs for the first WTRU, the first WTRU may determine (e.g., using method 1 or method 2) a CSI (e.g., a first report quantity or a second report quantity for a first or a second reporting window) based on a second CSI-RS that may be received at time unit t₂ and at frequency unit f₂.

The second WTRU may monitor the frequency units f₁ and f₂ at the time units t₁ and t₂, respectively, to receive the CSI-RSs for CSI determination. In examples, when a CSI timeline violation happens or occurs, the second WTRU may perform one or more of the following actions.

The second WTRU may determine index of the latest CSI-RS resource that does not violate the CSI timeline.

For example, the second WTRU may be configured to determine a CSI based on 4 CSI-RS resources, each 32 ports CSI-RS resources and a total of 128 CSI-RS ports across all CSI-RS resources.

For example, the WTRU may determine that the CSI timeline is being violated based on the latest CSI-RS resource, (e.g., based on the 4th CSI-RS resource). As an example, if the 4th CSI-RS resource is received after the CSI reference resource slot but the first 3 CSI-RS resources are received before the CSI reference resource slot, then the index of the latest CSI-RS resource that does not violates the CSI timeline would be the CSI-RS resource with index 3.

The WTRU may determine (e.g., using method 1 or method 2) a CSI (e.g., a partial CSI or a full CSI) for a smaller number of CSI-RS as compared to the configured number of CSI-RS ports.

In examples, the WTRU may be configured to determine RI, PMI and CQI using 4 CSI-RS resource where each resource is 32 ports. The CSI timeline violation may occur based on the 4th CSI-RS resource. The CSI timeline may not be violated based on the 3rd CSI-RS resources. In such a case, the number of ports across the 4 CSI-RS resources is 128. The number of ports across the 3 CSI-RS resources is 96. The WTRU may determine the full report quantity (e.g., the configured report quantity RI, PMI, and CQI) or a partial report quantity (e.g., RI, i1, and CQI) for a subset (e.g., 96) of the CSI-RS antenna ports instead of 128 CSI-RS antenna ports.

One or more CSI-RS resources in the CSI-RS resource set may be associated with a panel. The WTRU may determine a CSI and report a CSI for a subset of panels when the CSI timeline is violated.

In examples, the CSI-RS resource set may have two CSI-RS resources. The first CSI-RS resource may be associated with a first CSI-RS antenna ports panel. The second CSI-RS resource is associated with a second CSI-RS antenna ports panel. For example, the first CSI-RS resource may not violate the CSI timeline, whereas the second CSI-RS resource violates the CSI timeline. In such a case, the WTRU may determine a CSI for a first panel based on a first CSI-RS resource.

Examples involving CSI for network energy savings (NES) are discussed herein. In NR, enhancements to the CSI reporting setting have been introduced to enable the WTRU to report multiple CSIs (e.g., PMI, RI, CRI, CQI, LI) in a single CSI report. For example, the WTRU can be configured with an enhanced CSI report for Network Energy Savings (NES) to report multiple CSIs where the WTRU determines each CSI assuming a different measurement assumption and/or hypothesis. The CSI reporting configuration can be configured with a list of L sub-configurations where each sub-configuration is identified with an ID (1 to L) and the WTRU is configured to report one CSI per sub-configuration. Each sub-configuration corresponds to a list of one or more CSI-RS resources or CSI-RS antenna port subset and may also include a power offset value (e.g., powerOffset). The port subset indicates a number of antenna ports that are transmitting. The ports not in the subset are not transmitting. For example, the WTRU may receive a CSI-RS configuration with Nₚₒᵣₜₛ. The port subset indicates N₁<Nₚₒᵣₜₛ such that the WTRU determines a precoder for N₁ ports for the sub-configuration with the N₁ port subset. The power offset indicates the offset of the PDSCH EPRE relative to the CSI-RS resource.

For example, the sub-configuration may include a configured power offset (e.g., powerOffset). The WTRU may determine a CQI assuming that the ratio of PDSCH EPRE to CSI-RS EPRE is equal to powerControlOffset of the associated CSI-RS resource minus the poweroffset value associated with the sub-configuration

$$( e . g . , \frac{PDSCH EPRE}{CSI - RS EPRE} = powerControlOffset - powerOffset ) .$$

DL RS resources for NES CSI are considered herein. A WTRU may be configured to report a CSI. The DL RS resources for CSI measurements may be configured in the form of one or more DL RS resource set(s).

In examples which may be referred to as “Case1” herein, the CSI-RS resource set may have one or more CSI-RS resource(s) and a sub-configuration may be associated with (e.g., only with) a single CSI-RS resource in the CSI-RS resource set.

For example, the CSI-RS resource may have 4 CSI-RS resources. Sub-configuration1 may be associated with CSI-RS resource1 in the CSI-RS resource set. CSI-RS resource1 may be based on ports with indexes 1 to 32 ports. The sub-configuration1 may also be associated with an indicator (e.g., port-subset-indicator). The port-subset-indicator may be a 32-bits indicator. The port-subset-indicator may indicate the set of antenna ports that are active and the set of antenna ports that are not active.

In examples that are referred to as “Case1” may have a single CSI timeline. For example, in Case 1 a CSI may be determined based on a single CSI-RS resource in the CSI-RS resource set that is associated with the sub-configuration. For Case1, the examples presented in all of the paragraphs above may apply.

In examples, which are referred to as “Case2” herein, the CSI-RS resource set may have one or more CSI-RS resource(s) where a sub-configuration may be associated with one or more (e.g., at least two) CSI-RS resources in the CSI-RS resource set.

For example, a sub-configuration1 may be associated with CSI-RS resource1 in the CSI-RS resource set. However, sub-configuration1 may also be associated with CSI-RS resource2 in the CSI-RS resource set. CSI-RS resource1 may be an 8-port CSI-RS resource. CSI-RS resource2 may also be an 8-port CSI-RS resource. For example, CSI-RS resource1 may be based on ports with indexes 1 to 8 and CSI-RS resource2 may be based on ports with indexes 24 to 32.

Case2 may involve one or more than one single CSI timelines. The CSI timelines may depend on the CSI-RS resources associated with a sub-configuration.

A WTRU may determine one or multiple CSI timelines from the multiple sub-configurations.

In examples, when configured with L sub-configurations in one CSI report, the WTRU may determine to report a subset of sub-configurations (L_{subset}<L). In examples, the WTRU may determine to report L_{subset} sub-configurations if one or more of the CSI-RS associated to one of the sub-configurations violates one or more of the CSI timeline violation conditions.

The WTRU may be configured with one or more timeline reference symbol set per CSI-RS. Therefore, one CSI report configuration with multiple sub-configurations may be configured with multiple timeline reference symbol sets (e.g., Z′, T′). The WTRU may include the CSI in the CSI report for the sub-configurations where the CSI timeline violation does not happen. The WTRU may drop (e.g., not report) CSI reports where the CSI timeline violation does happen. In such a case, at the next CSI reporting occasion for this CSI report configuration, the WTRU may prioritize reporting the CSI sub-configurations which are dropped at the current CSI reporting occasion. For example, if the WTRU reports L_{subset} sub-configurations out of L at a first CSI reporting occasion, the WTRU may prioritize reporting the L-L_{subset} sub-configurations at a second CSI reporting occasion (e.g., if the CSI timeline violation conditions do not happen again).

Additionally, or alternatively, the WTRU may determine a single timeline reference symbol set (e.g., Z′, T′) for the CSI reporting configuration as a function of the multiple timeline reference symbols of the multiple sub-configurations. The WTRU may determine that the single timeline reference symbols are the earliest ones amongst the CSI-RSs associated with the multiple sub-configurations (e.g., the Z′ and T′ associated with the CSI-RS that is transmitted earliest in time amongst all CSI-RSs associated to the sub-configurations in the CSI reporting configuration). The WTRU may also determine the single timeline reference symbols as a function of the multiple timeline reference symbols of the multiple sub-configurations. For example, the WTRU may take the average of Z′ᵢ or T′ᵢ over i where i are the indices of the sub-configurations, or weighted average by the number of ports per sub-configuration

$$( e . g . , \frac{{N}_{i}}{N {i}_{ports}} * {Z}_{i}^{′} or \frac{{N}_{i}}{N {i}_{ports}}$$

where Nᵢ is the number of ports per sub-configuration and Niₚₒᵣₜₛ is the number of ports of the associated CSI-RS resource).

In examples, each port subset configuration may be configured with a timeline reference symbol as a function of the number of ports (e.g., N₁). For example, if the WTRU is configured with multiple sub-configurations, wherein each sub-configuration is configured with a N₁ port subset, then the WTRU may determine that one or more (e.g., all) the sub-configurations use the same timeline reference signal. If different port subsets are configured with different number of ports (e.g., N₁ and N₂), then the WTRU may determine timeline reference symbols per port subset.

The WTRU may receive explicit timeline reference symbols per sub-configuration.

Additionally, or alternatively, the WTRU may receive one timeline reference symbol set associated with a CSI-RS resource with Nₚₒᵣₜₛ. In such cases, the WTRU may determine the timeline reference symbol set for the N₁ ports of the port subset as a function of Nₚₒᵣₜₛ. For example, the WTRU may determine to scale the timeline reference symbol index as a function of the ratio of antenna port per subset to the total number of antenna ports

$$( e . g . , \frac{{N}_{1}}{{N}_{ports}} ) .$$

Additionally, or alternatively, the WTRU may receive one or more sub-configurations with different numbers of ports. The WTRU may be configured to use the timeline reference symbol set for a configured number of ports (e.g., Z′, T′ of the sub-configurations associated with a CSI-RS with N₁ ports).

UE may determine the CSI reporting quantities for the sub-configurations as a function of the one or more CSI timelines.

If the WTRU determines that a CSI timeline violation occurs for some of the sub-configurations and not for others, the WTRU may include partial CSI reporting quantity for the sub-configurations that are violating the timeline conditions. In examples, the WTRU may be configured with a first sub-configuration and a second sub-configuration (e.g., sub-configurations 1 and 2). One or more of CRI/RI/PMI/CQI may be configured for sub-configurations 1 and/or 2. When the WTRU is scheduled to report a CSI, it may determine that the timeline condition for sub-configuration 1 is violated, but not for sub-configuration 2. Then, the WTRU may determine to report a subset of reporting quantities (e.g., only RI) for the first sub-configuration, and report one or more (e.g., all) quantities for the second sub-configuration.

The WTRU may determine the CSI contents for the different sub-configurations as a function of the number of CSI-RS associated to sub-configurations where a CSI timeline violation occurs. The WTRU may receive a threshold on the number of CSI-RS timelines that are violated to determine the reporting contents. For example, the WTRU may be configured with L sub-configurations, a full reporting quantity of CRI/RI/PMI/CQI for each, and/or a threshold Lₜₕᵣ. If fewer than Lₜₕᵣ sub-configurations violate the CSI timeline, the WTRU may report partial quantities (e.g., CRI/RI) for the infringing sub-configurations, and/or full quantities (CRI/RI/PMI/CQI) for the non-infringing sub-configurations. If more than Lₜₕᵣ sub-configurations violate the timeline, the WTRU may report partial quantities for all L sub-configurations.

A WTRU may receive one or more CSI sub-configurations. Each sub-configuration may be associated with a configured powerOffset value. For example, the CSI configuration may include N sub-configurations. Each sub-configuration may have a configured power offset value (e.g., sub-configuration1 may be associated with poweroffset1, sub-configuration2 may be associated with poweroffset2, etc.). When a CSI timeline violation occurs, the WTRU may determine a CSI for a subset of the sub-configurations. For example, when the CSI timeline violation occurs, the WTRU may determine two sub-configurations (e.g., a first sub-configuration associated with the maximum power offset value and a second sub-configuration associated with the minimum power offset value).

In examples, sub-configuration1 is associated with poweroffset1 and sub-configuration2 is associated with poweroffset2. Poweroffset1 may be the maximum poweroffset value among one or more (e.g., all) of the configured poweroffset values. Poweroffset2 may be the minimum poweroffset value among one or more (e.g., all) of the configured poweroffset values. The WTRU may determine CSI only for the first and the second sub-configuration.

1. A wireless transmit/receive unit (WTRU) comprising a processor and memory, wherein the processor and memory are configured to:
receive a channel state information (CSI) configuration, wherein the CSI configuration comprises:
an indication of a first set of one or more quantities to report,
an indication of a first time window for determining quantities, and
a set of CSI reference instances;
determine that a CSI timing violation has occurred;
determine a CSI report using a second set of one or more quantities or a second time window for determining quantities, based on an association between the CSI timing violation and the set of CSI reference instances; and
send the CSI report.

2. The WTRU of claim 1, wherein the CSI configuration indicates a time instance for when CSI reporting is triggered and a time instance for the beginning of an uplink CSI report transmission.

3. The WTRU of claim 2, wherein the processor and memory are further configured to determine that a CSI timing violation has occurred based on the time instance for when CSI reporting is triggered or the time instance for the beginning of an uplink CSI report transmission.

4. The WTRU of claim 1, wherein the processor and memory are configured to determine to use the second set of one or more quantities or the second time window for determining quantities based on a determination that an instance associated with the CSI timing violation is earlier or later in time than a reference instance of the set of CSI reference instances.

5. The WTRU of claim 1, wherein the first and the second time windows for determining a set of one or more quantities each comprise a plurality of sub-windows, wherein each sub-window is associated with a time-duration.

6. The WTRU of claim 5, wherein the second time window comprises fewer sub-windows than the first time window.

7. The WTRU of claim 5, wherein the time-duration of the sub-windows comprised in the second time window is shorter in time than the time-duration of the sub-windows comprised in the first time window.

8. The WTRU of claim 1, wherein the second time window is shorter in time than the first time window.

9. The WTRU of claim 1, wherein the second time window begins earlier or later in time than the first time window.

10. The WTRU of claim 1, wherein the second set of one or more quantities comprises a subset of the first set of one or more quantities.

11. A method to be performed by a wireless transmit/receive unit (WTRU), the method comprising:
receiving a channel state information (CSI) configuration, wherein the CSI configuration comprises:
an indication of a first set of one or more quantities to report,
an indication of a first time window for determining quantities, and
a set of CSI reference instances;
determining that a CSI timing violation has occurred;
determining a CSI report using a second set of one or more quantities or a second time window for determining quantities, based on an association between the CSI timing violation and the set of CSI reference instances; and
sending the CSI report.

12. The method of claim 11, wherein the CSI configuration indicates a time instance for when CSI reporting is triggered and a time instance for the beginning of an uplink CSI report transmission.

13. The method of claim 12, further comprising determining that a CSI timing violation has occurred based on the time instance for when CSI reporting is triggered or the time instance for the beginning of an uplink CSI report transmission.

14. The method of claim 11, further comprising determining to use the second set of one or more quantities or the second time window for determining quantities based on a determination that an instance associated with the CSI timing violation is earlier or later in time than a reference instance of the set of CSI reference instances.

15. The method of claim 11, wherein the first and the second time windows for determining a set of one or more quantities each comprise a plurality of sub-windows, wherein each sub-window is associated with a time-duration.

16. The method of claim 15, wherein the second time window comprises fewer sub-windows than the first time window.

17. The method of claim 15, wherein the time-duration of the sub-windows comprised in the second time window is shorter in time than the time-duration of the sub-windows comprised in the first time window.

18. The method of claim 11, wherein the second time window is shorter in time than the first time window.

19. The method of claim 11, wherein the second time window begins earlier or later in time than the first time window.

20. The method of claim 11, wherein the second set of one or more quantities comprises a subset of the first set of one or more quantities.
